(19) United States
(12) Patent Application Publication
(10) Pub. No.: US 2012/0076043 A1
(43) Pub. Date: Mar. 29, 2012

(54) WIRELESS COMMUNICATION BASE STATION DEVICE, WIRELESS COMMUNICATION TERMINAL DEVICE, CONTROL CHANNEL TRANSMISSION METHOD, AND CONTROL CHANNEL RECEPTION METHOD

(75) Inventors: Akihiko Nishio, Kanagawa (JP); Masaru Fukuoka, Ishikawa (JP); Masayuki Hoshino, Kanagawa (JP); Seigo Nakao, Kanagawa (JP)

(73) Assignee: PANASONIC CORPORATION, Osaka (JP)

(21) Appl. No.: 13/376,479

(22) PCT Filed: Jun. 21, 2010
(86) PCT No.: PCT/JP2010/004125

§ 371 Date: Dec. 6, 2011

(30) Foreign Application Priority Data
Jun. 22, 2009 (JP) 2009-147812
Sep. 18, 2009 (JP) 2009-217135

(51) Int. Cl. H04W 72/04; H04W 24/00; H04L 12/26

(52) U.S. Cl. 370/252

(57) ABSTRACT

Disclosed is a wireless communication base station device which can prevent unnecessary HARQ retransmissions when a terminal is using a plurality of unit bands, even when the unit band through which data is transmitted differs from the unit band through which a PDCCH, to which the resource allocation information of said data is allocated, is transmitted. In this device, a control unit (102) generates, for each of a plurality of downlink unit bands, CFI information, which indicates the number of symbols used in a control channel to which resource allocation information of downlink data to be sent to the terminal has been allocated, with respect to the terminal, which communicates using a plurality of downlink unit bands; a scrambling unit (105) scrambles a control channel in a sequence corresponding to CFI information of downlink bands used in the allocation of downlink data, when, in a plurality of downlink unit bands, the downlink unit band used in the allocation of downlink data and the downlink unit band which transmits control channels to which resource allocation information has been allocated differ from one another.

### TECHNICAL FIELD

The present invention relates to a radio communication base station apparatus, radio communication terminal apparatus, control channel transmission method and control channel reception method.

### BACKGROUND ART

3GPP-LTE (3rd Generation Partnership Project Radio Access Network Long Term Evolution, hereinafter referred to as “LTE”) adopts OFDMA (Orthogonal Frequency Division Multiple Access) as a downlink communication scheme, and adopts SC-FDMA (Single Carrier Frequency Division Multiple Access) as an uplink communication scheme (e.g. see non-patent literatures 1, 2 and 3).

According to LTE, a radio communication base station apparatus (hereinafter, abbreviated as “base station”) performs communication by assigning resource blocks (RB's) in a system band to a radio communication terminal apparatus (hereinafter, abbreviated as “terminal”) per time unit called “subframe.” Furthermore, the base station transmits control information (resource assignment information) for reporting results of resource assignment of downlink data and uplink data to the terminal. This control information is transmitted to the terminal using a downlink control channel such as PDCCH (Physical Downlink Control Channel). In this case, the base station controls a resource amount for use in transmitting PDCCH, that is, the number of OFDM symbols, on a subframe unit basis, in accordance with an assignment number of terminals, etc. To be more specific, by using PCFICH (Physical Control Format Indicator Channel), the base station transmits a CFI (Control Format Indicator) that is a leading OFDM symbol and information for indicating the number of OFDM symbols that can be used for transmitting a PDCCH to a terminal. The terminal receives the PDCCH in accordance with the CFI detected from a received PCFICH. Here, each PDCCH occupies a resource that is configured by one or a plurality of continuous CCEs (Control Channel Elements). In LTE, among a number of CCEs occupied by a PDCCH (linked number of CCEs: CCE aggregation level), one of 1, 2, 4, or 8 is selected, according to the number of information bits of control information or the channel state of a terminal. LTE supports a frequency band having a width of maximum 20 MHz as a system bandwidth.

Furthermore, the base station simultaneously transmits a plurality of PDCCHs to assign a plurality of terminals to one subframe. In this case, the base station includes CRC bits masked (or scrambled) with destination terminal IDs to identify the respective PDCCH destination terminals in the PDCCHs and transmits the PDCCHs. The terminal demasks (or descrambles) the CRC bits in a plurality of PDCCHs which may be directed to the terminal with the terminal ID of the terminal and thereby blind-decodes the PDCCHs and detects a PDCCH directed to the terminal.

Furthermore, studies are being carried out on a method of limiting CCEs to be subjected to blind decoding for each terminal for the purpose of reducing the number of times blind decoding is performed at the terminal. This method limits a CCE area to be subjected to blind decoding (hereinafter referred to as “search space”) for each terminal. In LTE, a search space is set randomly for each terminal, and a number of CCEs configuring a search space is defined for each PDCCH CCE aggregation level. For example, for CCE aggregation levels 1, 2, 4, and 8, respectively, the number of CCEs configuring a search space—that is, the number of CCEs subject to blind decoding—is limited to six candidates (6 (=1×6) CCEs), six candidates (12 (=2×6) CCEs), two candidates (8 (=4×2) CCEs), and two candidates (16 (=8×2) CCEs), respectively. Thus, each terminal needs to perform blind decoding only on CCEs in the search space assigned to that terminal and can reduce the number of times to perform blind decoding. Here, the search space of each terminal is set using a hash function which is a function for performing randomization and the terminal ID of each terminal.

In LTE, ARQ (Automatic Repeat Request) is applied to downlink data from the base station to a terminal. That is, the terminal feeds back a response signal indicating the error detection result of the downlink data. The terminal performs a CRC on the downlink data, and if CRC=OK (no error), it feeds back an ACK (Acknowledgement) to the base station, while if CRC=NG (error exists), it feeds back a NACK (Negative Acknowledgement) to the base station as a response signal (that is, ACK/NACK signal). When the response signal thus fed back shows NACK, the base station transmits retransmission data to the terminal. Moreover, in LTE, data retransmission control, referred to as HARQ (Hybrid ARQ), which is a combination between error correction coding and ARQ, has been examined. In HARQ, upon receiving retransmitted data, a terminal makes it possible to improve reception quality on the terminal side by composing the retransmission data and date containing an error previously received.

Furthermore, standardization of 3GPP LTE-Advanced (hereinafter referred to as “LTE-A”) has been started which realizes further speed enhancement of communication compared to LTE. LTE-A is expected to introduce base stations and terminals (hereinafter referred to as “LTE+ terminals”) capable of communicating at a wideband frequency of 40 MHz or above to realize a maximum downlink transmission rate of 1 Gbps or above and a maximum uplink transmission rate of 500 Mbps or above. Furthermore, the LTE-A system is required to accommodate not only LTE+ terminals but also terminals supporting the LTE system (hereinafter referred to as “LTE terminals”).

LTE-A proposes a band aggregation scheme whereby communication is performed by aggregating a plurality of frequency bands to realize communication in a wideband of 40 MHz or above (e.g. see non-patent literature 1). For example, a frequency band having a bandwidth of 20 MHz is assumed to be a basic unit (hereinafter referred to as “component band”). Therefore, LTE-A realizes a system bandwidth of 40 MHz, for example, by aggregating two component bands. Also, both an LTE terminal and an LTE+ terminal can be accommodated in one component band. Additionally, in the following description, a component band in uplink line is referred to as “uplink component band”, and a component band in downlink line is referred to as “downlink component band.”

Also, in LTE-A, the following two methods have been investigated as reporting methods whereby resource assignment information of each component band is reported to a terminal from a base station (e.g. see non-patent literature 4). In the first reporting method, a base station reports resource assignment information of a plurality of component bands to a terminal by using a PDCCH disposed on each downlink component band for use in data transmission of a resource assignment subject. Then a terminal that performs wideband transmission (a terminal that uses a plurality of component bands) obtains resource assignment information of a plurality of component bands by receiving only a PDCCH placed in each downlink component band.

On the other hand, in the second reporting method, a base station reports resource assignment information of a plurality of component bands to a terminal by using a PDCCH placed on any one of downlink component bands. At this time, a component band to which data is assigned is reported to the terminal by PDCCH. That is, in the second reporting method, the base station sometimes transmits resource assignment information for component band of a resource assignment subject by using a PDCCH placed on a downlink component band different from the corresponding component band. Thus, the base station makes it possible to select a downlink component for use in transmitting PDCCH more flexibly.

### CITATION LIST

### Non-Patent Literature

### NPL 1

3GPP TS 36.211 V8.3.0, “Physical Channels and Modulation (Release 8),” May 2008

### NPL 2

3GPP TS 36.212 V8.3.0, “Multiplexing and channel coding (Release 8),” May 2008

### NPL 3

3GPP TS 36.213 V8.3.0, “Physical layer procedures (Release 8),” May 2008

### NPL 4

3GPP TSG RAN WG1 meeting, R1-092230, “PDCCH design for Carrier aggregation,” May 2009

### SUMMARY OF INVENTION

### Technical Problem

CFI of each component band, that is, a number of OFDM symbols used for transmitting PDCCH, is controlled independently for each component band, and reported to a terminal. Then, the terminal determines the CFI on each component band, and specifies a resource area (number of OFDM symbols, hereinafter, referred to as “PDCCH area”) for use in transmitting PDCCH and a data starting position (starting OFDM symbol).

In this case, since CFI is information of two bits with no error detection bit such as CRC added thereto, the terminal cannot detect an error of CFI. For this reason, in the case when a base station transmits resource assignment information for a component band of a resource assignment subject by using a PDCCH placed on the same component band as the corresponding component band, if the terminal erroneously determines the CFI information set on the component band, it erroneously specifies the PDCCH area. In this case, since the terminal erroneously receives the PDCCH, no data reception is carried out. Therefore, since the base station determines that no response signal from the terminal is detected (DTX), it retransmits the corresponding data.

On the other hand, as described earlier, a base station might transmit resource assignment information for a component band of a resource assignment subject by using a PDCCH placed on a component band different from the corresponding component band. For example, in FIG. 1 and FIG. 2, a base station transmits resource assignment information of downlink data (PDCCH (Physical Downlink Shared Channel) signal) to be transmitted by downlink component band 2 by using a PDCCH placed on downlink component band 1 different from downlink component band 2. In FIG. 1 and FIG. 2, the base station transmits CFI by using a PCFICH placed on each of downlink component bands 1 and 2. In FIG. 1 and FIG. 2, CFI information of downlink component band 1 is defined as CFI=3 (that is, PDCCH area with 3 OFDM symbols), and CFI information of downlink component band 2 is defined as CFI=1 (that is, PDCCH area with 1 OFDM).

First, an explanation will be given by exemplifying a case where, as shown in FIG. 1, both of pieces of CFI information for downlink component band 1 for use in transmitting a PDCCH and CFI information for downlink component band 2 of a resource assignment subject indicated by resource assignment information contained in the PDCCH are determined correctly. In this case, the terminal is allowed to detect a PDCCH addressed to the terminal of its own by blind decoding, and can specify a starting OFDM symbol of downlink data addressed to the terminal of its own (in FIG. 1 OFDM symbol immediately after the PDCCH area corresponding to CFI=1, that is, the 2nd OFDM symbol from the leading portion of a subframe). Therefore, as shown in FIG. 1, the terminal receives downlink data based upon the frequency resource to which downlink data addressed to the terminal of its own is assigned, indicated by resource assignment information contained in the received PDCCH, and the specified starting OFDM symbol.

Moreover, in the case when there is any error in the decoded result of downlink data, as shown in FIG. 1, the terminal stores the downlink data containing the error in an HARQ buffer in succession from the starting OFDM symbol, and transmits a NACK signal to the base station. Then, the terminal composes the retransmission data from the base station and received data stored in the HARQ buffer so that receipt quality on the terminal side can be improved.

Next, an explanation will be given by exemplifying a case where, as shown in FIG. 2, although CFI information (CFI=3 in FIG. 2) for downlink component band 1 for use in transmitting a PDCCH is determined correctly, CFI information (CFI=1 in FIG. 2) for downlink component band 2 of a resource assignment subject, indicated by resource assignment information contained in the PDCCH, is erroneously determined as CFI=3. In this case, as shown in FIG. 2, the terminal can detect the PDCCH in downlink component band 1 in which CFI information has been determined correctly. That is, since the terminal can specify the frequency resource to which downlink data addressed to the terminal of its own is assigned, it carries out a decoding process on the downlink data.

However, as shown in FIG. 2, the terminal erroneously specifies a portion corresponding to 3 OFDM symbols from the leading portion of the subframe in association with CFI=3 of downlink component band 2 as a PDCCH area. That is, the PDCCH area specified by the terminal is different from a PDCCH area configured by the base station (PDCCH area corresponding to CFI=1) by a portion corresponding to 2 OFDM symbols (portion indicated by slanting lines in FIG. 2). Therefore, as shown in FIG. 2, the terminal specifies an OFDM symbol immediately after the OFDM symbol specified as a PDCCH area within a time domain (that is, the 4th OFDM symbol from the leading portion of the subframe) as a starting OFDM symbol of downlink data. For this reason, since the terminal receives downlink data from an erroneous resource, it fails to decode data correctly.

Moreover, upon determination that there is any error in the decoded result of downlink data, the terminal stores the received downlink data in the HARQ buffer. At this time, as shown in FIG. 2, the terminal stores the data in the HARQ buffer, with the 4th OFDM symbol from the leading portion of the subframe (OFDM symbol immediately after a PDCCH area corresponding to CF=3) being defined as a starting OFDM symbol of downlink data. That is, the terminal erroneously stores downlink data in the HARQ buffer in succession from an OFDM symbol different from the actual starting OFDM symbol of downlink data (OFDM symbol immediately after the PDCCH area corresponding to CFI=1).

For this reason, upon receipt of retransmission data HARQ-retransmitted from the base station, the terminal erroneously composes the received data stored in the HARQ buffer, that is, data stored from an erroneous starting position (OFDM symbol immediately after the PDCCH area corresponding to CFI=3 in FIG. 2), with the retransmission data retransmitted from a starting position set by the base station (OFDM symbol immediately after the PDCCH area corresponding to CFI=1 in FIG. 2). As a result, a further HARQ retransmission occurs, and upon reaching a predetermined maximum number of retransmission, a retransmission occurs even in upper layer (for example, RLC layer).

In this manner, in the case when a terminal uses a plurality of component bands, if a component band for use in transmitting data and a component band for use in transmitting a PDCCH to which resource assignment information of the data is assigned are different from each other, if the terminal erroneous determines CFI of the component band for use in transmitting the data, there is an increase of delay in transmitting data, and there is also a useless resource consumption due to retransmission of HARQ. Moreover, frequent retransmissions of an upper layer cause an increase in the processing amount of the base station.

The objective of the present invention is to provide a base station, a terminal, a control channel transmission method and a control channel reception method that make it possible to prevent useless retransmissions of HARQ, even in the case when upon allowing the terminal to use a plurality of component bands, a component band for use in transmitting data and a component band for use in transmitting a PDCCH to which resource assignment information for the data is assigned are different from each other.

### Solution to Problem

A base station of the present invention, which is a radio communication base station apparatus that transmits a plurality of pieces of downlink data addressed to a radio communication terminal apparatus by using a plurality of downlink component bands, employs a configuration having: a control channel generation section that generates a plurality of control channels to which pieces of resource assignment information of a plurality of pieces of downlink data are respectively assigned; a CFI information generation section that generates CFI information indicating a number of symbols that are usable for the control channels for each of a plurality of downlink component bands; and a scrambling section which, in the case when, in a plurality of downlink component bands, a downlink component band for use in assigning the downlink data and a downlink component band for use in transmitting the control channels to which the pieces of resource assignment information are assigned are different from each other, scrambles the control channels by using a sequence corresponding to the CFI information of the downlink component band for use in assigning the downlink data.

A terminal of the present invention, which is a radio communication terminal apparatus that receives a plurality of pieces of downlink data using a plurality of downlink component bands, employs a configuration having: a reception section that obtains CFI information indicating a number of symbols that are usable for the control channel to which pieces of resource assignment information of downlink data addressed to the corresponding apparatus is assigned, for each of a plurality of downlink component bands; and a decoding section that descrambles the control channels transmitted by a downlink component band different from a downlink component band for use in assigning the downlink data, among a plurality of downlink component bands, by using the sequence corresponding to the CFI information for use in assigning the downlink data.

A control channel transmission method of the present invention, which is a control channel transmission method in a radio communication base station apparatus that transmits a plurality of pieces of downlink data addressed to a radio communication terminal apparatus by using a plurality of downlink component bands, includes: a control channel generation step of generating a plurality of control channels to which pieces of resource assignment information of a plurality of pieces of downlink data are respectively assigned; a generation step of generating CFI information indicating a number of symbols that are usable for the control channels for each of a plurality of downlink component bands; and a scrambling step of scrambling the control channels by using a sequence corresponding to the CFI information of the downlink component band for use in assigning the downlink data, in the case when, in a plurality of downlink component bands, a downlink component band for use in assigning the downlink data and a downlink component band for use in transmitting the control channels to which the pieces of resource assignment information are assigned are different from each other.

A control channel reception method of the present invention, which is a control channel reception method in a radio communication terminal apparatus that receives a plurality of pieces of downlink data by using a plurality of downlink component bands, includes: a reception step of receiving CFI information indicating a number of symbols that are usable for a control channel to which pieces of resource assignment information of downlink data addressed to the corresponding apparatus is assigned, for each of a plurality of downlink component bands; and a decoding step of descrambling the control channels transmitted by a downlink component band different from a downlink component band for use in assigning the downlink data by using a sequence corresponding to the CFI information of the downlink component band for use in assigning the downlink data, in each of a plurality of downlink component bands.

### Advantageous Effects of Invention

In accordance with the present invention, even in the case when, upon allowing a terminal to use a plurality of component bands, a component band for use in transmitting data and a component band for use in transmitting a PDCCH to which resource assignment information for the data is assigned are different from each other, it is possible to prevent useless HARQ retransmissions.

### BRIEF DESCRIPTION OF THE DRAWINGS

FIG. 1 is a diagram illustrating PDCCH transmission processing (in the case when a terminal receives CFI information correctly);

FIG. 2 is a diagram illustrating PDCCH transmission processing (in the case when a terminal receives CFI information erroneously);

FIG. 3 is a block diagram illustrating a configuration of a base station according to Embodiment 1 of the present invention;

FIG. 4 is a block diagram illustrating a configuration of a terminal according to Embodiment 1 of the present invention;

FIG. 5 is a diagram illustrating PDCCH transmission processing according to Embodiment 1 of the present invention;

FIG. 6 is a diagram illustrating a PDCCH area according to Embodiment 2 of the present invention;

FIG. 7 is a block diagram illustrating a configuration of a base station according to Embodiment 4 of the present invention;

FIG. 8 is a diagram illustrating a setting method for a search space according to Embodiment 4 of the present invention;

FIG. 9 is a block diagram illustrating a configuration of a base station according to Embodiment 5 of the present invention;

FIG. 10 is a block diagram illustrating an inner configuration of a PDCCH processing section according to Embodiment 5 of the present invention;

FIG. 11 is a block diagram illustrating an inner configuration of a PDCCH processing section according to Embodiment 6 of the present invention;

FIG. 12 is a block diagram illustrating an inner configuration of a PDCCH processing section according to Embodiment 7 of the present invention;

FIG. 13 is a block diagram illustrating an inner configuration of a PDCCH processing section according to Embodiment 8 of the present invention;

FIG. 14 is a block diagram illustrating an inner configuration of a PDCCH processing section according to Embodiment 9 of the present invention; and

FIG. 15 is a diagram illustrating a reading process of a circular buffer according to Embodiment 9 of the present invention.

### DESCRIPTION OF EMBODIMENTS

Hereinafter, embodiments of the present invention will be described in detail with reference to the accompanying drawings. In the following embodiments, the same components will be assigned the same reference numerals and overlapping explanations will be omitted.

### Embodiment 1

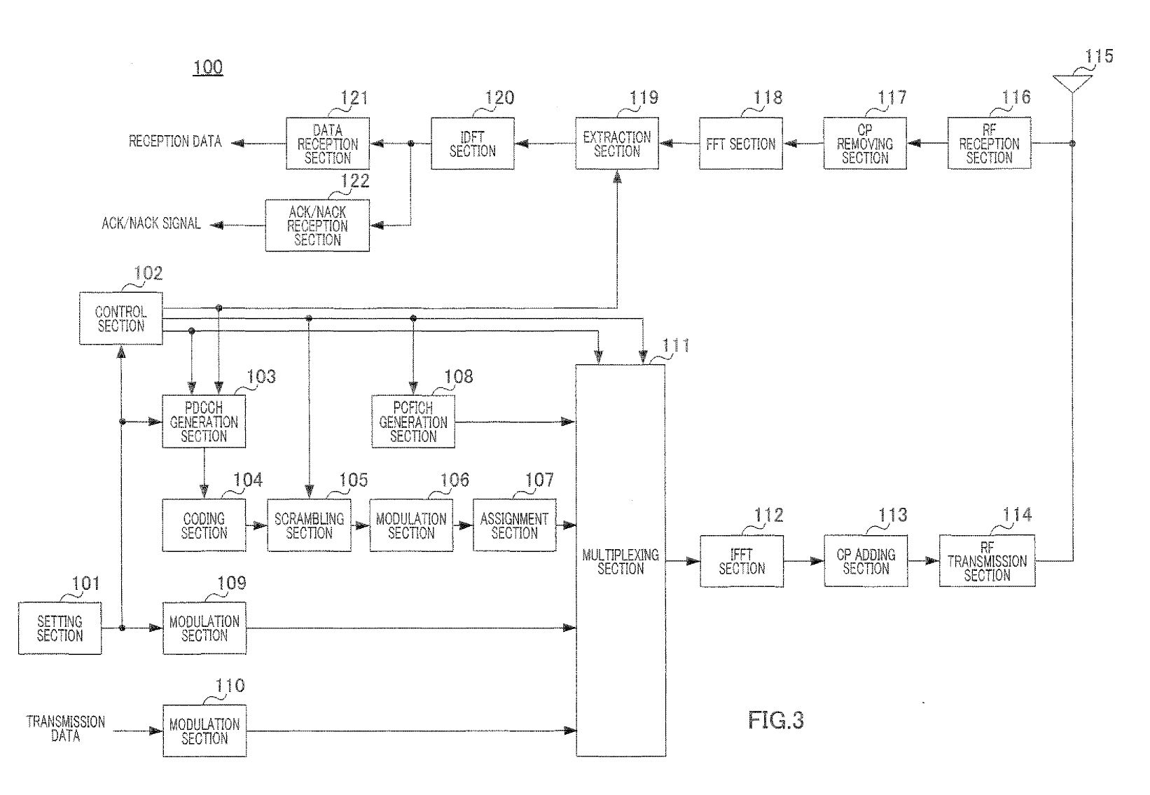

FIG. 3 is a block diagram illustrating a configuration of base station 100 according to the present embodiment.

In base station 100 shown in FIG. 3, setting section 101 sets (configures) one or a plurality of component bands to use for an uplink and a downlink per terminal according to a required transmission rate, amount of data transmission or the like. Moreover, setting section 101 configures a downlink component band for transmitting a PDCCH signal to which resource assignment information of data to be transmitted for each component band is assigned for each of the uplink and the downlink. Setting section 101 outputs setting information including information on component bands configured for each terminal and the downlink component band for transmitting the PDCCH signal to control section 102, PDCCH generation section 103, and modulation section 109.

Control section 102 generates uplink resource assignment information that indicates an uplink resource (for example, PUSCH) to which uplink data of a terminal is assigned, and downlink resource assignment information that indicates a downlink resource (for example, PDSCH) to which downlink data addressed to a terminal is assigned. In this case, the resource assignment information includes assignment information of a resource block (RB: Resource Block), data MCS information, and information relating to HARQ retransmission, such as information (NDI: New Data Indicator) or RV (Redundancy version) information, which indicates whether the data is new data or resent data. Control section 102 then outputs the uplink resource assignment information to PDCCH generation section 103 and extraction section 119 and outputs the downlink resource assignment information to PDCCH generation section 103 and multiplexing section 111. Here, control section 102 assigns uplink assignment information and downlink assignment information (that is, resource assignment information for a terminal) to a PDCCH arranged in the downlink component band set in each terminal, based on setting information inputted from setting section 101. More specifically, control section 102 assigns each piece of resource assignment information to the PDCCH disposed in the downlink component band configured for each component band corresponding to a resource assignment subject indicated by the resource assignment information. A PDCCH is made up of one or a plurality of CCEs. Furthermore, the number of CCEs used by base station 100 is set based on propagation path quality (CQI: Channel Quality Indicator) of the assignment target terminal and a control information size so that the terminal can receive control information at a necessary and sufficient error rate. Furthermore, based upon the number of CCEs to be used by the PDCCH to which control information (for example, resource assignment information) is assigned in each downlink component band, control section 102 determines the number of OFDM symbols to be used for transmitting the PDCCH for each of the downlink component bands, and generates CFI information indicating the determined number of OFDM symbols. Then, control section 102 outputs the CFI information for each downlink component band to scrambling section 105, PCFICH generation section 108 and multiplexing section 111.

PDCCH generation section 103 generates a PDCCH signal including the uplink resource assignment information and downlink resource assignment information inputted from control section 102 in the downlink component band set for each terminal indicated by the setting information inputted from setting section 101. Furthermore, PDCCH generation section 103 adds a CRC bit to the PDCCH signal to which the uplink resource assignment information and downlink resource assignment information have been assigned and further masks (or scrambles) the CRC bit with the terminal ID. PDCCH generation section 103 then outputs the masked PDCCH signal to coding section 104.

Coding section 104 carries out a channel coding process on a PDCCH signal for each component band inputted from PDCCH generation section 103, and outputs the coded PDCCH signal to scrambling section 105.

In the case when the downlink component band in which the PDCCH signal inputted from coding section 104 is transmitted and a downlink component band of a resource assignment subject indicated by the downlink resource assignment information contained in the PDCCH signal are different from each other, scrambling section 105 scrambles the corresponding PDCCH signal by using a scrambling sequence corresponding to CFI information of the downlink component band (downlink component band to be used for assigning downlink data) of resource assignment subject among pieces of CFI information of respective downlink component bands inputted from control section 102. In other words, upon transmitting a PDCCH signal inputted from coding section 104 by using a downlink component band different from the downlink component band of the resource assignment subject indicated by the downlink resource assignment information contained in the PDCCH signal, scrambling section 105 scrambles the PDCCH signal by using a scrambling sequence corresponding to CFI information of the downlink component band for use in assigning the downlink data. Then, scrambling section 105 outputs a PDCCH signal that has been scrambled to modulation section 106. In contrast, in the case when the downlink component band in which the PDCCH signal inputted from coding section 104 is transmitted and a downlink component band of a resource assignment subject indicated by the downlink resource assignment information contained in the PDCCH signal are identical to each other, scrambling section 105 outputs the corresponding PDCCH signal, as it is, to modulation section 106.

Modulation section 106 modulates the PDCCH signal inputted from scrambling section 105, and outputs a PDCCH signal that has been modulated to assignment section 107.

Assignment section 107 assigns PDCCH signals for respective terminals inputted from modulation unit 106 to CCEs inside a search space for each terminal in each downlink component band. For example, assignment section 107 calculates a search space of each of the plurality of downlink component bands set in each terminal from the terminal ID of each terminal, CCE number calculated using a hash function for performing randomization and the number of CCEs (L) making up the search space. That is, assignment section 107 sets the CCE number calculated using the terminal ID of a certain terminal and a hash function at the starting position (CCE number) of the search space of the terminal and sets consecutive CCEs corresponding to the number of CCEs L from the starting position as the search space of the terminal. In this case, assignment section 107 calculates a search space in the component band configured by setting section 101 for the respective PDCCHs indicating resource assignment information of data for each component band data. Assignment section 107 then outputs the PDCCH signal assigned to the CCE to multiplexing section 111.

Based upon CFI information for each downlink component band inputted from control section 102, PCFICH generation section 108 generates a PCFICH signal to be transmitted for each downlink component band. For example, PCFICH generation section 108 generates information of 32 bits by coding CFI information (CFI bits) of 2 bits of each downlink component band, QPSK-modulates the generated information of 32 bits and thereby generates a PCFICH PCFICH generation section 108 then outputs the generated PCFICH signal to multiplexing section 111.

Modulation section 109 modulates the setting information inputted from setting section 101, and outputs the modulated setting information to multiplexing section 111.

Modulation section 110 modulates inputted transmission data (downlink data) after channel coding and outputs the modulated transmission data signal to multiplexing section 111.

Multiplexing section 111 multiplexes a PDCCH signal inputted from assignment section 107, a PCFICH signal inputted from PCFICH generation section 108, setting information inputted from modulation section 109 and data signal (that is, a PDSCH signal) inputted from modulation section 110. Here, based upon CFI information of each downlink component band inputted from control section 102, multiplexing section 111 determines the number of OFDM symbols for use in mapping PDCCH for each downlink component band. Furthermore, multiplexing section 111 maps the PDCCH signal and data signal (PDSCH signal) to each downlink component band based on the downlink resource assignment information inputted from control section 102. Multiplexing section 111 may also map the setting information to a PDSCH. Multiplexing section 111 then outputs the multiplexed signal to IFFT (Inverse Fast Fourier Transform) section 112.

IFFT section 112 transforms the multiplexed signal inputted from multiplexing section 111 into a time waveform and CP (Cyclic Prefix) adding section 110 adds a CP to the time waveform and thereby obtains an OFDM signal.

RF transmission section 114 applies radio transmission processing (up-conversion, D/A conversion or the like) to the OFDM signal inputted from CP adding section 113 and transmits the OFDM signal via antenna 115.

On the other hand, RF reception section 116 applies radio reception processing (down-conversion, A/D conversion or the like) to a received radio signal received in a reception band via antenna 115 and outputs the received signal obtained to CP removing section 117.

CP removing section 117 removes a CP from the received signal and FFT (Fast Fourier Transform) section 118 transforms the received signal after the CP removal into a frequency domain signal.

Extraction section 119 extracts uplink data of each terminal and PUCCH signal (e.g. ACK/NACK signal) from the frequency domain signal inputted from FFT section 118, based on the uplink resource assignment information (e.g. uplink resource assignment information 4 subframes ahead) inputted from control section 102. IDFT (Inverse Discrete Fourier transform) section 120 transforms the signal extracted by extraction section 119 into a time domain signal and outputs the time domain signal to data reception section 121 and ACK/NACK reception section 122.

Data reception section 121 decodes uplink data out of the time domain signal inputted from IDFT section 120. Data reception section 121 outputs the decoded uplink data as received data.

ACK/NACK reception section 122 extracts an ACK/NACK signal from each terminal corresponding to the downlink data (PDSCH signal) out of the time domain signal inputted from IDFT section 120, and carries out an ACK/NACK determination on the ACK/NACK signal. Based upon the result of the ACK/NACK determination by ACK/NACK reception section 122, base station 100 transmits new data or resent data in the next transmission timing.

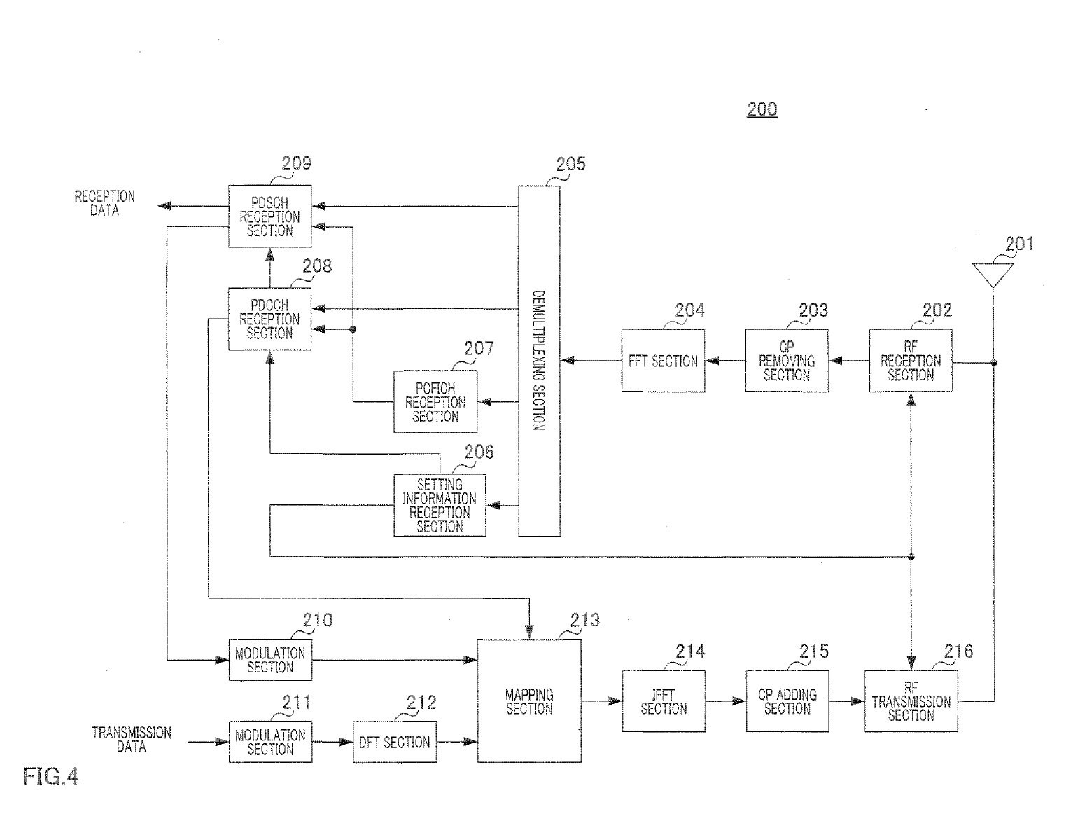

FIG. 4 is a block diagram illustrating a configuration of terminal 200 according to the present embodiment. Terminal 200 communicates with base station 100 by using a plurality of downlink component bands. When there is any error in the received data, terminal 200 stores the received data in a HARQ buffer, and at the time of retransmission, composes retransmission data with the received data stored in the HARQ buffer, and decodes the resulting composite data.

In terminal 200 shown in FIG. 4, RF reception section 202 is configured to be able to change a reception band and changes the reception band based on band information inputted from setting information reception section 206. RF reception section 202 then applies radio reception processing (down-conversion, A/D conversion or the like) to the received radio signal (here, OFDM signal) received in the reception band via antenna 201 and outputs the received signal obtained to CP removing section 203.

CP removing section 203 removes a CP from the received signal and FFT section 204 transforms the received signal after the CP removal into a frequency domain signal. The frequency domain signal is outputted to demultiplexing section 205.

Demultiplexing section 205 demultiplexer the signal inputted from FFT section 204 into a control signal (e.g. RRC signaling) of an upper layer including setting information, a PCFICH signal, a PDCCH signal and a data signal (that is, PDSCH signal). Demultiplexing section 205 then outputs the control signal to reception section 206, the PCFICH signal to PCFICH reception section 207, the PDCCH signal to PDCCH reception section 208, and the PDSCH signal to PDSCH reception section 209.

Setting information reception section 206 reads information indicating an uplink component band and downlink component band for use in data communication configured for this terminal and information indicating a downlink component band for use in transmitting a PDCCH signal to which resource assignment information of data for each component band is assigned, from a control signal inputted from demultiplexing section 205. Setting information reception section 206 outputs then the read information to PDCCH reception section 208, RF reception section 202, and RF transmission section 216 as band information. Furthermore, setting information reception section 206 reads information indicating the terminal ID set in the terminal from the control signal inputted from demultiplexing section 205 and outputs the read information to PDCCH reception section 208 as terminal ID information.

PCFICH reception section 207 extracts CFI information from the PCFICH signal inputted from demultiplexing section 205. That is, PCFICH reception section 207 obtains the CFI information indicating the number of OFDM symbols to use for a PDCCH to which uplink resource assignment information and downlink resource assignment information are assigned for each of the plurality of downlink component bands set in this terminal. PCFICH reception section 207 then outputs the extracted CFI information to PDCCH reception section 208 and PDSCH reception section 209.

PDCCH reception section 208 blind-decodes the PDCCH signal inputted from demultiplexing section 205 and obtains a PDCCH signal (resource assignment information) directed to the terminal. Here, the PDCCH signal is assigned to each CCE (that is, PDCCH) arranged in the downlink component band set in the terminal indicated in the band information inputted from setting information reception section 206. To be more specific, PDCCH reception section 208 identifies the number of OFDM symbols in which the PDCCH is arranged for each downlink component band, based on the CFI information inputted from PCFICH reception section 207. PDCCH reception section 208 then calculates a search space of the terminal of its own using the terminal ID of the terminal indicated in the terminal ID information inputted from setting information reception section 206. In this case, PDCCH reception section 208 sets a search space for each downlink component band in which a PDCCH indicating resource assignment information of data for each component band inputted from setting information reception section 206. PDCCH reception section 208 then demodulates and decodes the PDCCH signal assigned to each CCE in the calculated search space.

PDCCH reception section 208 performs blind decoding of each PDCCH signal that carries out a resource assignment of data for each component band. For example, when there are two component bands (downlink component band 1 and downlink component band 2), PDCCH reception section 208 performs blind decoding on a PDCCH for use in data assignment of downlink component band 1 and blind decoding on a PDCCH for use in data assignment of downlink component band 2, respectively. Moreover, upon blind decoding a PDCCH transmitted through a downlink component band different from the downlink component band for use in assigning downlink data, PDCCH reception section 208 descrambles the PDCCH signal after the demodulation by using a scrambling sequence corresponding to CFI information of downlink component band to be used for downlink data assignment. For example, in downlink component band 1, upon blind decoding a PDCCH for use in data assignment of downlink component band 2, PDCCH reception section 208 descrambles the PDCCH signal by using a scrambling sequence corresponding to CFI information of downlink component band 2. In the same manner, in downlink component band 2, upon blind decoding a PDCCH for use in data assignment of downlink component band 1, PDCCH reception section 208 descrambles the PDCCH signal by using a scrambling sequence corresponding to CFI information of downlink component band 1. Moreover, PDCCH reception section 208 carries out a decoding process on the PDCCH signal after the descrambling.

PDCCH reception section 208 demasks a CRC bit with the terminal ID of the terminal indicated in the terminal ID information for the decoded PDCCH signal and thereby decides the PDCCH signal which results in CRC=OK (no error) to be a PDCCH signal directed to the terminal. PDCCH reception section 208 outputs downlink resource assignment information included in the PDCCH signal directed to the terminal to PDSCH reception section 209 and outputs uplink resource assignment information to mapping section 213. In contrast, in the case when no PDCCH signal to make CRC=OK is detected, PDCCH reception section 208 determines that no data assignment addressed to the terminal of its own exists in the current subframe, and enters a stand-by state until the next subframe.

PDSCH reception section 209 extracts received data (downlink data) from the PDSCH signals of a plurality of downlink component bands inputted from demultiplexing section 205, based on the downlink resource assignment information of the plurality of downlink component bands inputted from PDCCH reception section 208 and CH information of a plurality of downlink component bands inputted from PCFICH reception section 207. Furthermore, PDSCH reception section 209 performs error detection on the extracted received data (downlink data). When the error detection result shows that an error is found in the received data, PDSCH reception section 209 generates a NACK signal as the ACK/NACK signal, whereas when no error is found in the received data, PDSCH reception section 209 generates an ACK signal as the ACK/NACK signal and outputs the ACK/NACK signal to modulation section 210. In the case when any error is found in the received data, PDSCH reception section 209 stores the extracted received data in a HAQR buffer (not shown). Upon receipt of retransmission data, PDSCH reception section 209 composes the received data stored in the HARQ buffer with the retransmission data, and carries out an error detection on the resulting composite signal. When base station 100 transmits two data blocks (Transport Blocks) by spatially multiplexing PDSCH transmission through MIMO (Multiple-Input Multiple-Output) or the like, PDSCH reception section 209 generates ACK/NACK signals for the respective data blocks.

Modulation section 210 modulates the ACK/NACK signal inputted from PDSCH reception section 209. When base station 100 transmits two data blocks by spatially multiplexing the PDSCH signal in each downlink component band, modulation section 210 applies QPSK modulation to the ACK/NACK signal. On the other hand, when base station 100 transmits one data block, modulation section 210 applies BPSK modulation to the ACK/NACK signal. That is, modulation section 210 generates one QPSK signal or BPSK signal as the ACK/NACK signal per downlink component band. Modulation section 210 then outputs the modulated ACK/NACK signal to mapping section 213.

Modulation section 211 modulates transmission data (uplink data) and outputs the modulated data signal to DFT (Discrete Fourier transform) section 212.

DFT section 212 transforms the data signal inputted from modulation section 211 into a frequency domain signal and outputs the plurality of frequency components obtained to mapping section 213.

Mapping section 213 maps the data signal inputted from DFT section 212 to PUSCHs arranged in the uplink component band according to the uplink resource assignment information inputted from PDCCH reception section 208. Also, mapping section 213 maps an ACK/NACK signal inputted from modulation section 210 onto a PUCCH placed in an uplink component band.

Modulation section 210, modulation section 211, DFT section 212, and mapping section 213 may also be provided for each component band.

IFFT section 214 converts a plurality of frequency components mapped to a PUSCH to a time-domain waveform, and CP adding section 215 adds a CP to that time-domain waveform.

RF transmission section 216 is configured to be able to change a transmission band and sets a transmission band based on the band information inputted from setting information reception section 206. RF transmission section 216 then applies radio transmission processing (up-conversion, D/A conversion or the like) to the signal with a CP added and transmits the signal via antenna 201.

Next, details of operations of base station 100 and terminal 200 will be described.

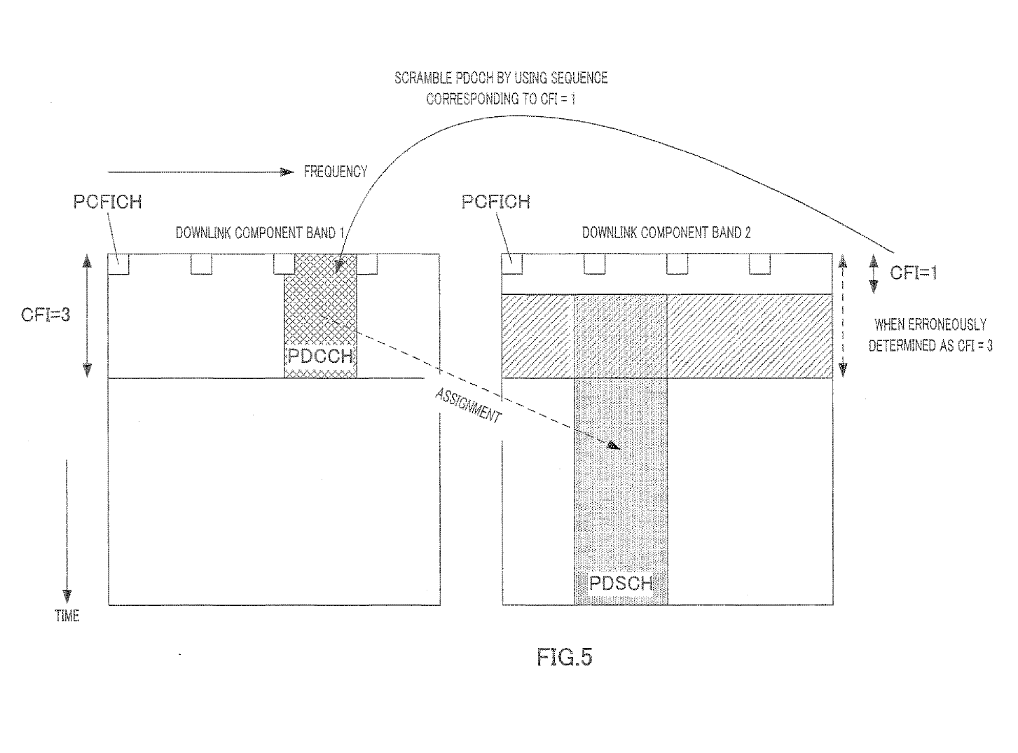

In the following explanation, the resource assignment to downlink data will be discussed. Setting section 101 (FIG. 3) of base station 100 configures two downlink component bands (component band 1 and component band 2) shown in FIG. 5 on terminal 200 (FIG. 4). Control section 102 of base station 100 generates CFI information indicating the number of OFDM symbols (PDCCH area) that is used by PDCCH disposed in each downlink component band. In a certain subframe shown in FIG. 5, control section 102 of base station 100 sets CFI information of downlink component band 1 to CFI=3 (that is, 3 OFDM symbols), as well as setting CFI information of downlink component band 2 to CFI=1 (that is, 1 OFDM symbol). Additionally, CFI information holds any one of values of CFI=1 to 3 (that is 1 to 3 OFDM symbols).

Moreover, as shown in FIG. 5, base station 100 transmits resource assignment information of downlink data (PDSCH signal) to be transmitted by downlink component band 2 by using a PDCCH disposed on downlink component band 1. In other words, in FIG. 5, downlink component band (downlink component band 2) to be used for assignment of downlink data and downlink component band (downlink component band 1) to be used for transmitting a PDCCH on which resource assignment information of the downlink data is assigned are different from each other. Moreover, in FIG. 5, base station 100 also transmits resource assignment information of downlink data (PDSCH signal) to be transmitted by downlink component band 1 by using a PDCCH disposed on downlink component band 1 (not shown). That is, base station 100 transmits a plurality of pieces of downlink data addressed to terminal 200 by using a plurality of downlink component bands, and also transmits a plurality of PDCCH signals to which respective pieces of resource assignment information of a plurality of pieces of downlink data are assigned.

At this time, as shown in FIG. 5, scrambling section 105 of base station 100 scrambles the corresponding PDCCH (PDCCH disposed on downlink component band 1 shown in FIG. 5) to which the resource assignment information of downlink data to be transmitted by downlink component band 2 is assigned by using a scrambling sequence corresponding to CFI information (CFI=1) of downlink component band 2 in which the downlink data are transmitted.

For example, in accordance with the following equation 1, scrambling section 105 performs a multiplication between a scrambling sequence c′ (i) corresponding to each piece of CFI information and a bit string b (i) (in this case, i indicates an index of a bit string) of a PDCCH signal encoded into a channel code by encoding section 104, on a bit-unit basis so as to generate a bit string ˜(i) of the PDCCH signal after the scrambling.

[1]

\tilde{b}(i)=(b(i)+c′(i)) mod 2 (Equation 1)

In this case, scrambling sequence c′ (i) is a bit string of ‘0’ or ‘1’, and operator “mod” represents modulo operation. Moreover, in FIG. 5, three types of scrambling sequences c′ (i) that respectively correspond to CFI=1 to 3 are used.

With this arrangement, in downlink component band 1 shown in FIG. 5, a PDCCH signal scrambled by the scrambling sequence corresponding to CFI=1 is transmitted, and in downlink component band 2, a PDSCH signal is transmitted. Additionally, scrambling section 105 does not carry out a scrambling process on a PDCCH (not shown) disposed on downlink component band 1 on which resource assignment information of downlink data (PDSCH signal) to be transmitted by downlink component band 1 is assigned.

PCFICH reception section 207 of terminal 200 extracts CFI information of downlink component band 1 from a PCFICH signal assigned to a PCFICH resource of downlink component band 1 shown in FIG. 5, and also extracts CFI information of downlink component band 2 from a PCFICH signal assigned to a PCFICH resource of downlink component band 2.

PDCCH reception section 208 specifies a PDCCH area (the number of OFDM symbols) of downlink component band 1 based upon CFI information of downlink component band 1 shown in FIG. 5, and also specifies a PDCCH area (the number of OFDM symbols) of downlink component band 2 based upon CFI information of downlink component band 2. Moreover, PDCCH reception section 208 respectively blind-decodes a PDCCH signal to which resource assignment information for downlink data to be transmitted by downlink component band 1 is assigned and a PDCCH signal to which resource assignment information for downlink data to be transmitted by downlink component band 2 is assigned. In this case, in downlink component band 1 shown in FIG. 5, upon blind-decoding the PDCCH signal to which resource assignment information for downlink data to be transmitted by downlink component band 2 is assigned, PDCCH reception section 208 descrambles the PDCCH signal by using a scrambling sequence corresponding to CFI information of downlink component band 2 extracted by PCFICH reception section 207. In contrast, in downlink component band 1 shown in FIG. 5, upon blind-decoding the PDCCH signal to which resource assignment information for downlink data to be transmitted by downlink component band 1 is assigned, PDCCH reception section 208 does not carry out descrambling. The same is true for downlink component band 2 shown in FIG. 5.

In other words, upon blind-decoding a PDCCH signal transmitted by a downlink component band that is different from the downlink component band to be used for assignment of downlink data in a plurality of component bands, PDCCH reception section 208 descrambles the PDCCH signal by using a scrambling sequence corresponding to CFI information of downlink component band to be used for assignment of downlink data.

The following description exemplifies a state in which terminal 200 correctly determines CFI information (CFI=1) of downlink component band 2 to be used for assignment of downlink data, shown in FIG. 5. Here, terminal 200 correctly determines CFI information (CFI=3) of downlink component band 1 shown in FIG. 5.

In this case, upon blind-decoding a PDCCH signal to which resource assignment information of downlink data to be transmitted by downlink component band 2 is assigned, in downlink component band 1 shown in FIG. 5, PDCCH reception section 208 of terminal 200 descrambles the PDCCH signal by using a scrambling sequence corresponding to CFI=1, that is, CFI information of downlink component band 2. That is, PDCCH reception section 208 uses the same scrambling sequence as the scrambling sequence (scrambling sequence corresponding to CFI=1) used in scrambling section 105 of base station 100. Therefore, in PDCCH reception section 208, as a result of decoding of the PDCCH signal, CRC=OK (no error) of PDCCH signal is obtained.

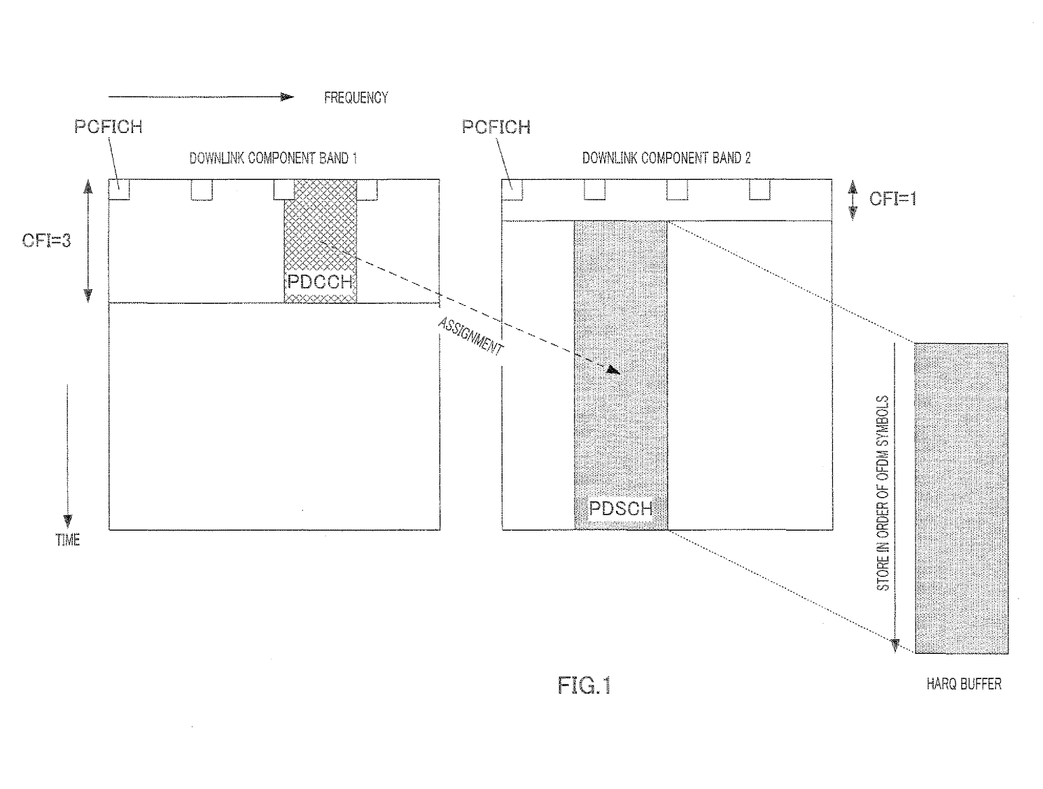

With this arrangement, PDSCH reception section 209 can extract downlink data from a PDSCH signal based upon a frequency resource of downlink data indicated by resource assignment information contained in the PDCCH signal and a starting OFDM symbol of downlink data specified by the CFI information. Moreover, for example, as shown in FIG. 1, PDSCH reception section 209 stores the extracted downlink data in the HARQ buffer successively from the normal starting OFDM symbol. In this case, even when there is any, error in the decoded result of downlink data, terminal 200 can thus improve reception quality of the data by composing retransmission data from base station 100 and received data stored in the HARQ buffer.

Next, the following description will discuss a state in which terminal 200 erroneously determines CFI information (CFI=1) of downlink component band 2 shown in FIG. 5 as CFI=3. Here, terminal 200 correctly determines CFI information (CFI=3) of downlink component band 1 shown in FIG. 5.

In this case, upon blind-decoding a PDCCH signal to which resource assignment information of downlink data transmitted by downlink component band 2 in downlink component band 1 shown in FIG. 5, PDCCH reception section 208 of terminal 200 descrambles the PDCCH signal by using a scrambling sequence corresponding to CFI 3 that is CFI information of downlink component band 2. In this case, scrambling section 105 of base station 100 scrambles the PDCCH signal by using a scrambling sequence corresponding to CFI=1. That is, the scrambling sequence (corresponding to CFI=1) used in the scrambling in base station 100 and the scrambling sequence (corresponding to CFI=3) used in the descrambling in terminal 200 are different from each other. Therefore, even when a PDCCH signal is decoded, PDCCH reception section 208 fails to obtain a correct decoded result, and the PDCCH signal shows CRC=NG (error exists).

In this manner, only when CFI information of downlink component band for use in transmitting downlink data is determined correctly, terminal 200 can obtain a PDCCH signal by descrambling the PDCCH signal to which resource assignment information of the downlink data is assigned by using the same scrambling sequence as the scrambling sequence used in base station 100.

In contrast, in the case when CFI information of downlink component band for use in transmitting downlink data is erroneously received, terminal 200 descrambles a PDCCH signal to which resource assignment information of the downlink data is assigned by using a scrambling sequence different from the scrambling sequence used in base station 100. For this reason, when the CFI information of downlink component band for use in transmitting downlink data is erroneously determined, terminal 200 fails to correctly decode the PDCCH signal. That is, upon erroneous determination of CFI information of downlink component for use in transmitting downlink data, terminal 200 also erroneously receives the PDCCH signal to which the resource assignment information of downlink data is assigned. In other words, if CRC is OK on the PDCCH signal to which the resource assignment information of downlink data is assigned, this means that the CFI information of downlink component band used for transmitting the downlink data has been determined correctly.

In the case when a PDCCH signal is not decoded correctly, since terminal 200 does not transmit an ACK/NACK signal (that is, DTX), base station 100 transmits the same data, not as retransmission data, but as firstly transmitted data. That is, base station 100 gives HARQ information (NDI: New Data Indicator) indicating the first transmission in control information.

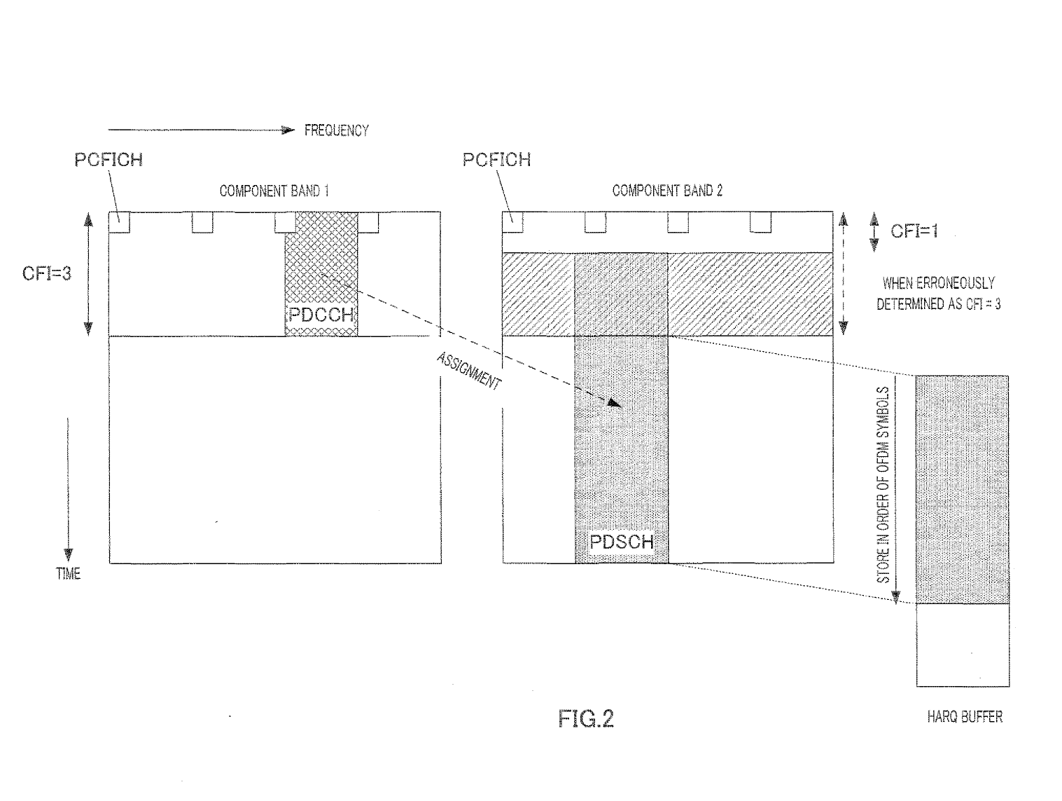

Therefore, in the case when there is any error in CFI information of downlink component band for use in transmitting downlink data, since terminal 200 does not receive downlink data by using the corresponding downlink component band, the downlink data is not stored at an erroneous position in the HARQ buffer. For this reason, as shown in FIG. 2, no useless HARQ retransmission caused by storing downlink data at an erroneous position of the HARQ buffer occurs, thereby preventing frequent retransmissions of an upper layer (for example, RLC layer). Thus, it becomes possible to reduce a delay in data transmission and also to suppress resource consumption for use in HARQ retransmission; thus, it is possible to improve the throughput and also to reduce the processing amount in base station 100.

As described above, terminal 200 is designed so that, only when CFI information of downlink component band for use in transmitting downlink data is determined correctly, terminal 200 can receive the downlink data of the downlink component band, by carrying out a descrambling process by using a scrambling sequence corresponding to the CFI information received for each downlink component band. In other words, by allowing base station 100 to notify CFI information for each downlink component band, terminal 200 can determine that the CFI information is correct, by using only the scrambling sequence corresponding to the CFI information received by the downlink component band used for transmitting the downlink data in the descrambling process. That is, since terminal 200 does not need to carry out a descrambling process by using scrambling sequences corresponding to all pieces of CFI information (in this case, CFI=1 to 3) available, it is possible to prevent an increase in the number of blind decoding processes. Consequently, it becomes possible to prevent an increase in the processing amount required for descrambling in terminal 200, and consequently to prevent useless HARQ retransmissions. Since the number of blind decoding processes is not increased in terminal 200, it is possible to prevent an increase in the erroneous detection rate (False Alarm) of a PDCCH signal addressed to the terminal of its own. Moreover, since CFI information needs not to be included in control information to be transmitted by a PDCCH, it is possible to prevent an increase in control overheads.

In this manner, in accordance with the present embodiment, even in the case when, upon allowing a terminal to use a plurality of component bands, a component band used for transmitting data and a component band used for transmitting a PDCCH to which resource assignment information of the data is assigned are different from each other, it is possible to prevent useless HARQ retransmissions.

In the present invention, in the case when a scrambling process using another scrambling sequence c (i) in accordance with a cell ID or the like is simultaneously carried out, the base station may scramble the PDCCH signal by using the following equation 2 in place of equation 1.

[2]

\tilde{b}(i)=(b(i)+c(i)+c′(i)) mod 2 (Equation 2)

Moreover, in the present invention, the base station and the terminal may be preliminarily provided with a table indicating mutual correspondence between CFI information and scrambling sequences. Alternatively, the base station and the terminal may use a scrambling sequence that is generated by using CFI information and its cell ID as initial values for a sequence generation device. For example, a value, obtained by adding CFI information to a value calculated from a cell ID defined by LTE, may be used as the initial value for the sequence generation device. With this arrangement, since the designing of LTE can be utilized in the maximum level, the terminal can be more easily configured in relation to LTE.

Moreover, the present embodiment is explained by exemplifying a case in which the base station carries out a scrambling process on a bit string of a PDCCH signal as shown in equation 1. However, in the present invention, the base station may carry out a scrambling process on symbols of a PDCCH signal that has been modulated, on a symbol unit basis. In this case, the scrambling sequence corresponds to a binary sequence of ‘1’ or ‘−1’, or a vector sequence. That is, the base station multiplies a symbol of the PDCCH signal that has been modulated, by the scrambling sequence on a symbol unit basis.

The present embodiment is explained by exemplifying a case in which, only in the case when a PDCCH signal is transmitted by using a downlink component band different from the downlink component band that is a resource assignment subject indicated in downlink resource assignment information contained in the PDCCH signal, the base station carries out a scrambling process on the PDCCH signal by using a scrambling sequence corresponding to the CFI information of the downlink component band that is a resource assignment subject. However, in the present invention, even in the case when the PDCCH signal is transmitted by using the same component band as the downlink component band serving as a resource subject indicated by downlink resource assignment information contained in the PDCCH signal, the base station may carry out a scrambling process on the PDCCH signal by using a scrambling sequence corresponding to the CFI information of the downlink component band serving as a resource subject for the PDCCH signal. In this case, in the base station and the terminal, since the same transmission process and reception process are carried out on any PDCCH signal, the transmitter-receiver (in the base station and terminal) can be simplified.

Moreover, the present embodiment is explained by exemplifying a case in which, by using a scrambling sequence corresponding to CFI information of downlink component band for use in transmitting downlink data, the base station carries out a scrambling process on a PDCCH signal to which the resource assignment information of the downlink data is assigned. However, in place of the scrambling process, the base station may carry out an interleaving process in accordance with the CFI information (that is, rearranging of bit strings after the encoding or rearranging of symbols after the modulation), and the same effects as those of the present invention can be obtained. For example, the base station and terminal may commonly possess interleaving patterns in association with CFI information preliminarily.

### Embodiment 2

In the present embodiment, an explanation will be given by exemplifying a case in which a PDCCH signal to which resource assignment information of data to be transmitted by each component band can be assigned to any one of downlink component bands. That is, the base station configures a common search space for respective downlink component bands, and assigns a PDCCH signal to a search space configured in any one of downlink component bands. Moreover, the terminal carries out a blind decoding process on the PDCCH signal to which resource assignment information of data to be transmitted by each of component bands in the search space of each downlink component band.

The following description will discuss the embodiment more specifically. Although base station 100 (FIG. 3) and terminal 200 (FIG. 4) of the present embodiment have the same structures as those of Embodiment 1, operations of setting section 101, scrambling section 105, assignment section 107, setting information reception section 206 and PDCCH reception section 208 are different from those of Embodiment 1.

Different from Embodiment 1, setting section 104 (FIG. 3) of base station 100 does not configure a downlink component band used for transmitting a PDCCH signal to which resource assignment information of data to be transmitted by each component band is assigned. Therefore, setting information to be inputted to setting information reception section 206 (FIG. 4) of terminal 200 does not include information indicating downlink component bands for use in transmitting PDCCH signals to which pieces of resource assignment information of data of the respective component bands are assigned. That is, base station 100 can transmit a PDCCH signal by using any one of a plurality of downlink component bands configured in the respective terminals.

In the case when a downlink component band used for transmitting a PDCCH signal inputted from encoding section 104 is different from a downlink component band serving as a resource assignment subject indicated by downlink resource assignment information contained in the PDCCH signal are different from each other, as well as when the number of CCEs of each PDCCH signal configured by control section 102 is a predetermined number of CCEs or more (for example, 4 CCEs or more), scrambling section 105 scrambles the PDCCH signal by using a scrambling sequence corresponding to CFI information of the downlink component band serving as a resource assignment subject indicated by resource assignment information contained in the PDCCH signal. In contrast, in the case when the number of CCEs of each PDCCH signal configured by control section 102 is less than the predetermined number of CCEs (for example, less than 4 CCEs), scrambling section 105 does not carry out a scrambling process on the PDCCH signal.

Assignment section 107 configures a common search space for all of a plurality of downlink component bands configured in each terminal. Thus, assignment section 107 assigns a PDCCH signal inputted from modulation section 106 to a CCE within the search space of any one of downlink component bands of a plurality of downlink component bands.

On the other hand, in the same manner as in assignment section 107, PDCCH reception section 208 (FIG. 4) of terminal 200 configures a common search space for a plurality of downlink component bands configured in the terminal of its own. Moreover, PDCCH reception section 208 carries out a blind decoding process on the PDCCH signal with respect to each of CCE aggregation level (for example, CCE aggregation levels: 1, 2, 4) available within the search space for each downlink component band. However, in the case when, upon blind-decoding a PDCCH transmitted by a downlink component band different from a downlink component band used for downlink data assignment, the CCE aggregation level is a predetermined number of CCEs (for example, 4 CCEs) or more, PDCCH reception section 208 descrambles the PDCCH signal (PDCCH assignment candidate) of the CCE aggregation level by using a scrambling sequence corresponding to CFI information extracted by PCFICH reception section 207 (that is, CFI information of downlink component band used for downlink data assignment). In contrast, in the case when the CCE aggregation level is less than a predetermined number of CCEs (for example, 4 CCEs), PDCCH reception section 208 does not descramble the PDCCH Next, details of operations of base station 100 and terminal 200 will be described.

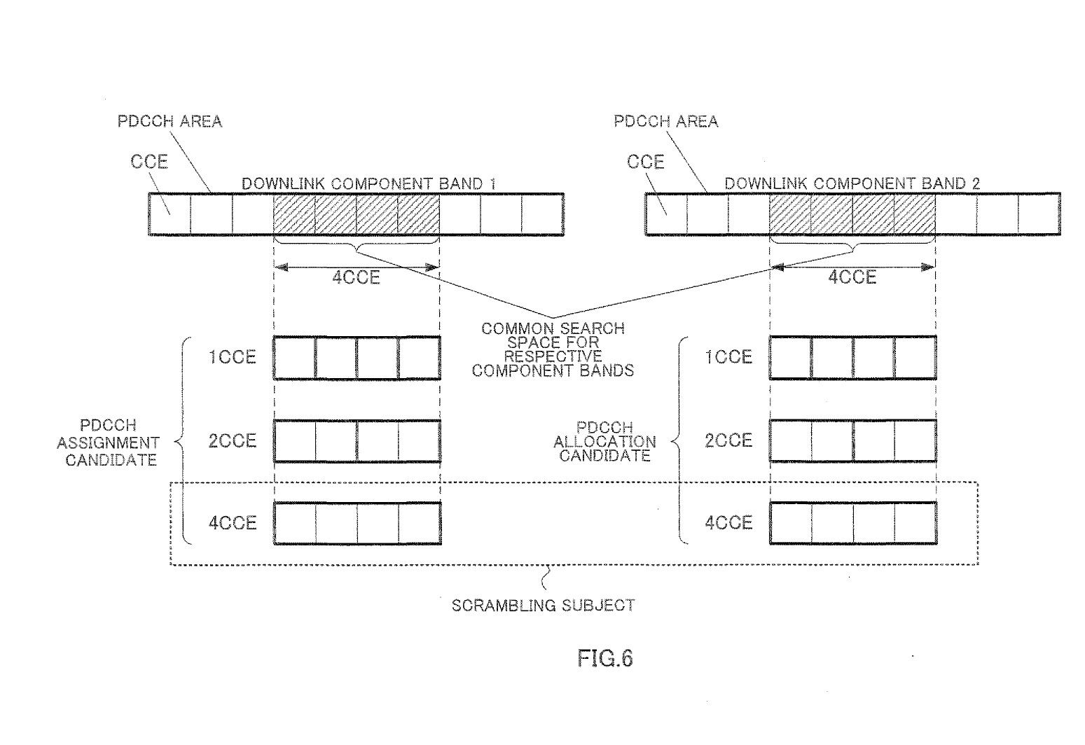

In the following description, in PDCCH areas of downlink component band 1 and downlink component band 2 configured in terminal 200, assignment section 107 (FIG. 3) of base station 100 and PDCCH reception section 208 (FIG. 4) of terminal 200 configure 4 CCEs per band as a search space commonly used for the respective component bands, as shown in FIG. 6. That is, to the search space configured in downlink component band 1 and downlink component band 2 shown in FIG. 6, either a PDCCH for use in data assignment of component band 1 or a PDCCH for use in data assignment of component band 2 is assigned. Moreover, a CCE aggregation level in PDCCH forms any one of values of 1, 2 and 4. That is, as shown in FIG. 6, in the search space of one downlink component band, the PDCCH assignment candidates of the respective CCE aggregation levels (1, 2, 4) are four candidates in the case of 1 CCE, two candidates in the case of 2 CCEs, and four candidates in the case of 4 CCEs, and seven candidates are provided in the total. In other words, assignment section 107 selects 1 CCE within the search space shown in FIG. 6 in the case that the CCE aggregation level is 1 CCE, selects 2 CCEs within the search space shown in FIG. 6 in the case that the CCE aggregation level is 2 CCEs, and selects all the CCEs within the search space shown in FIG. 6 in the case that the CCE aggregation level is 4 CCEs.

In this case, as the CCE aggregation level becomes greater, more resources are used, so that base station 100 can transmit a PDCCH signal at a lower coding rate. Therefore, assignment section 107 selects the CCE aggregation level based upon reception quality information (CQI) reported by terminal 200. More specifically, in the case of poor reception quality, base station 100 needs to transmit a PDCCH signal at a lower coding rate so that the PDCCH signal can be received with sufficient quality. For this reason, in the case of poor reception quality, assignment section 107 selects larger number in the CCE aggregation level, for example, 4 CCEs. In contrast, in the case of good reception quality, base station 100 can transmit a PDCCH signal with sufficient reception quality even at a high coding rate. Thus, in the case of good reception quality, assignment section 107 selects a smaller CCE aggregation level, for example, 1 CCE.

Here, in base station 100 and terminal 200, 4 CCEs are preliminarily determined as the CCE aggregation level that is a threshold value determining whether or not a scrambling process (or a descrambling process) should be carried out by using a scrambling sequence corresponding to CFI information.

Therefore, in the ease when the downlink component band in which the PDCCH signal inputted from coding section 104 is transmitted and a downlink component band of a resource assignment subject indicated by the downlink resource assignment information contained in the PDCCH signal are different from each other, as well as when the CCE aggregation level to be used for transmitting the PDCCH signal inputted from encoding section 104 are 4 CCEs or more, scrambling section 105 of base station 100 scrambles the PDCCH signal by using a scrambling sequence corresponding to CFI information inputted from control section 102. That is, in FIG. 6, only in the case when the CCE aggregation level to be used for transmitting the PDCCH signal is 4 CCEs, scrambling section 105 carries out the scrambling process on the PDCCH signal by using CFI information. That is, among the seven candidates of PDCCH assignment candidates shown in FIG. 6, in the six candidates except for one candidate having 4 CCEs in the CCE aggregation level, scrambling section 105 does not carry out the scrambling process on the PDCCH signal by using CFI information.

On the other hand, as shown in FIG. 6, PDCCH reception section 208 of terminal 200 carries out a blind decoding process on each of PDCCH assignment candidates within the search space configured respectively in downlink component band 1 and downlink component band 2 set in the terminal of its own. More specifically, after attempting to decode the PDCCH signal and carrying out a demasking process thereon by using the terminal ID of the terminal of its own, PDCCH reception section 208 carries out an error detection on the PDCCH signal by CRC.

However, upon blind-decoding the PDCCH assignment candidate having the predetermined CCE aggregation level or more, PDCCH reception section 208 further carries out a descrambling process on the PDCCH signal after the decoding process, by using a scrambling sequence corresponding to the CFI information of a downlink component band different from the downlink component band on which the PDCCH signal is disposed, in the same manner as in Embodiment 1. That is, upon carrying out the blind decoding process on the PDCCH assignment candidate having the predetermined CCE aggregation level or more, PDCCH reception section 208 carries out two kinds of blind decoding processes, that is, the blind decoding without carrying out descrambling and the blind decoding with descrambling, on each of the downlink component bands. In this case, the blind decoding process without descrambling refers to a blind decoding process to be carried out on the PDCCH signal to which resource assignment information of the downlink data to be transmitted by the same component band is assigned. In contrast, the blind decoding process with descrambling refers to a blind decoding process to be carried out on the PDCCH signal to which resource assignment information of the downlink data to be transmitted by a difference component band is assigned.

In other words, with respect to PDCCH assignment candidates of 4 CCEs in the CCE aggregation level, PDCCH reception section 208 assumes two cases, that is, a case in which a scrambling process is carried out by using CFI information of a downlink component band different from the downlink component band to which the PDCCH assignment candidate is disposed, and a case in which a scrambling process using CFI information is not carried out. Then, PDCCH reception section 208 carries out blind decoding processes of two kinds, that is, blind decoding with descrambling and blind decoding without descrambling, on two downlink component bands (downlink component band 1 and downlink component band 2 shown in FIG. 6). For example, in FIG. 6, in downlink component band 1 (or downlink component band 2), PDCCH reception section 208 carries out two kinds of blind decoding processes, that is, blind decoding with descrambling using a scrambling sequence corresponding to CFI information of downlink component band 2 (or downlink component band 1), and blind decoding without descrambling using CFI information, on the PDCCH assignment candidate of 4 CCEs in the CCE aggregation level.

On the other hand, with respect to PDCCH assignment candidates other than 4 CCEs in the CCE aggregation level (in the case of 1 CCE or 2 CCEs shown in FIG. 6), PDCCH reception section 208 carries out only the blind decoding process without descrambling using CFI information on each of downlink component bands.

For example, in the case when base station 100 can assign a PDCCH signal to any one of the downlink component bands, if terminal 200 carries out a descrambling process by using a scrambling sequence corresponding to CFI information on all the CCE aggregation level (in this case, CCE aggregation level, 1, 2, 4), the number of decoding attempts of total 28 (=7 (PDCCH assignment candidates)×2 (kinds of blind decoding)×2 (number of downlink component bands)) times are required in the two downlink component bands. In contrast, in the present embodiment, in the two downlink component bands, the number of decoding attempts can be reduced to total 16 (=6 (PDCCH assignment candidates of less than 4 CCEs in the CCE aggregation level)×1 (kind of blind decoding)+(1 (PDCCH assignment candidate having 4 CCEs or more in the CCE aggregation level)×2 (kinds of blind decoding processes)×2 (number of downlink component bands)) times.

In general, since a PCFICH signal containing CFI information is transmitted to all the terminals within a cell of base station 100, it is transmitted with virtually constant transmission power. Consequently, as a terminal is located closer to a cell boundary, it is subjected to reception errors of CFI information more frequently, and as a terminal is located closer to the center of the cell, it is less subjected to reception errors of CFI information.

Moreover, as described earlier, base station 100 assigns a PDCCH having a smaller CCE aggregation level to a terminal closer to the center of the cell having good reception quality. In contrast, base station 100 assigns a PDCCH having a larger CCE aggregation level to a terminal closer to a cell boundary having poor reception quality.

Therefore, even when base station 100 does not carry out a scrambling process using CFI information on a PDCCH signal having a smaller CCE aggregation level (a PDCCH signal having less than 4 CCEs in FIG. 6) that is less possible to be used for a terminal located close to a cell boundary where reception errors of CFI information easily occur (that is, highly possible to be used for a PDCCH located close to the center of the cell that is less subjected to reception errors of CFI information), reception errors of CFI information hardly occur. For this reason, the possibility of a HARQ retransmission caused by reception error of CFI information is low.

In contrast, by carrying out a scrambling process using CFI information on a PDCCH signal having larger CCE aggregation level (a PDCCH signal having 4 CCEs or more in FIG. 6), that is highly possible to be used for a terminal located close to a cell boundary where reception errors of CFI information easily occur, base station 100 makes it possible to prevent useless HARQ retransmissions due to reception errors of CFI information in the same manner as in Embodiment 1.

In accordance with the present embodiment, even in the case when a terminal uses a plurality of component bands and a common search space is configured in a plurality of downlink component bands for a PDCCH signal to which resource assignment information for each component band is assigned, it is possible to prevent useless HARQ retransmissions in the same manner as in Embodiment 1. Moreover, in accordance with the present embodiment, since the base station carries out a scrambling process by using CFI information only on a PDCCH signal (PDCCH signal having a predetermined threshold value or more in the CCE aggregation level) for a terminal located close to a cell boundary where reception errors of CFI information easily occur, it is possible to reduce the number of blind decoding processes in a terminal.

In the present invention, the predetermined number of CCE (4 CCEs in the present embodiment), that is a threshold value for use in determining whether or not a scrambling process should be carried out by using a scrambling sequence corresponding to CFI information, may be a fixed value and may be notified to a terminal by a base station.

Moreover, in the present invention, the number of downlink component bands to be configured in a terminal may be three or more. Here, in the case when pieces of CFI information, extracted by a plurality of downlink component bands that are different from the downlink component band that is a subject of blind decoding, are the same, the terminal may carry out the blind decoding process with descrambling by the use of extracted CFI information only one time. For example, in a structure where three downlink component bands 1 to are configured in a terminal, in the ease when pieces of CFI information, extracted in two downlink component bands 2 and 3 other than the downlink component band 1 that is a subject of blind decoding, are the same, with respect to a blind decoding process with descrambling by using CFI information to be carried out in downlink component band 1 that is a subject of blind decoding, the terminal may carry out a descrambling process by the use of extracted CFI information only one time.

### Embodiment 3

In the present embodiment, in the same manner as in Embodiment 2, an explanation will be given by exemplifying an arrangement in which a base station can assign a PDCCH signal to which resource assignment information of data to be transmitted by each component band is assigned, to any one of downlink component bands, and the base station assigns a control signal (for example, a PDCCH signal) to a terminal by using a plurality of formats.

Here, the control information formats include a format having a large number of information bits and a format having a small number of information bits. For example, upon carrying out a MIMO transmission (spatially multiplexing transmission), since it is necessary to notify proceeding information or MCS information or the like for a plurality of streams, the number of information bits of control information format becomes greater. In contrast, in the case of non-MIMO transmission or in the case when the resource assignment is limited to assignment to continuous RBs, the number of information bits of control information format becomes smaller.

For example, in LTE, upon downlink resource assignment, the base station can carry out the assignment to a terminal by selecting either one of two kinds of formats, that is, Format 1A that is a format to be used when the resource assignment is limited to continuous RB assignment and a format corresponding to a terminal mode (for example, Format 2 that is a format for MIMO transmission). For example, in the case when reception quality of a terminal is good, the base station carries out an assignment for data to be MIMO transmitted by using Format 2 (format having a large number of information bits). In contrast, in the case when reception quality of a terminal is poor, the base station carries out an assignment for data by using Format 1A (format having a small number of information bits), so that it is possible to suppress overhead of control information.

That is, it is highly possible for the base station to use Format 2 (format having a large number of information bits) for a terminal having good reception quality located in the vicinity of the center of a cell, while it is highly possible for the base station to use Format 1A (format having a small number of information bits) for a terminal having poor reception quality located in the vicinity of a cell boundary. In other words, it is highly possible for the base station to use Format 2 (format having a large number of information bits) for a terminal located in the vicinity of the center of a cell where reception errors of CFI information easily occur, while it is highly possible for the base station to use Format 1A (format having a small number of information bits) for a terminal located in the vicinity of a cell boundary, which is easily subjected to reception errors in CFI information.

Therefore, in the present embodiment, upon transmitting control information (a PDCCH signal) by using any one of a plurality of formats, the base station carries out a scrambling process by using CFI information only on control information having the smallest number of information bits, in the same manner as in Embodiment 1.

The following description will discuss the present embodiment more specifically. Here, although base station 100 (FIG. 3) and terminal 200 (FIG. 4) relating to the present embodiment have the same structures as those of Embodiment 1, operations of setting section 101, control section 102, scrambling section 105, assignment section 107, setting information reception section 206 and PDCCH reception section 208 are different from those of Embodiment 1.

In the same manner as in Embodiment 2, setting section 101 (FIG. 3) of base station 100 does not configure a downlink component band for use in transmitting a PDCCH signal to which resource assignment information for data to be transmitted by each of component bands is assigned. Therefore, setting information to be inputted to setting information reception section 206 (FIG. 4) of terminal 200 does not contain information indicating a downlink component band for use in transmitting a PDCCH signal to which resource assignment information for data of each component band is assigned. That is, base station 100 can transmit a PDCCH signal by using any one of a plurality of downlink component bands configured in each terminal. Moreover, setting section 101 configures formats of PDCCH signal (for example, two kinds of formats of Format 1A and Format 2) that can be configured on each terminal.

Based upon reception capability and the like of a terminal (for example, reception quality information reported from each terminal), control section 102 configures a format of a PDCCH signal. Then, in the same manner as in Embodiment 1, control section 102 generates uplink resource assignment information to a terminal and downlink resource assignment information, in accordance with the configured format.

In the case when the downlink component band in which the PDCCH signal inputted from coding section 104 is transmitted and a downlink component band of a resource assignment subject indicated by the downlink resource assignment information contained in the PDCCH signal are different, scrambling section 105 scrambles only the corresponding PDCCH signal that is transmitted with the format having the smallest number of information bits among formats of a PDCCH signal that can be configured by control section 102, by using a scrambling sequence corresponding to CFI information of the downlink component band of resource assignment subject indicated by the resource assignment information contained in the PDCCH signal. That is, scrambling section 105 does not carry out a scrambling process on a PDCCH signal other than the PDCCH signal that is transmitted with the format having the smallest number of information bits.

In the same manner as in Embodiment 2, assignment section 107 configures a common search space for all of a plurality of downlink component bands configured in a terminal. Thus, assignment section 107 assigns a PDCCH signal inputted from modulation section 106 to a CCE within the search space of any one of downlink component bands of a plurality of downlink component bands.

On the other hand, setting information reception section 206 (FIG. 4) of terminal 200 reads information indicating a format of a PDCCH signal contained in setting information, and outputs the read format of the PDCCH signal to PDCCH reception section 208.

In the same manner as in assignment section 107, PDCCH reception section 208 configures a common search space for a plurality of downlink component bands configured in the terminal of its own. Then, PDCCH reception section 208 carries out a blind decoding process on the PDCCH signal within the search space for each downlink component band. However, upon carrying out a blind decoding process on a PDCCH signal that is transmitted with the format having the smallest number of information bits among formats of a PDCCH signal inputted from configuration information reception section 206, PDCCH reception section 208 carries out a descrambling process on a PDCCH signal by using a scrambling sequence corresponding to CFI information (that is, CFI information of downlink component band to be used for assignment of downlink data) extracted by PCFICH reception section 207. In contrast, PDCCH reception section 208 does not carry out a descrambling process on a PDCCH signal other than the PDCCH signal of the format having the smallest number of information bits.

Next, details of operations of base station 100 and terminal 200 will be described.

In the following description, in the same manner as in Embodiment 2, in PDCCH areas of downlink component band 1 and downlink component band 2 configured in terminal 200, assignment section 107 (FIG. 3) of base station 100 and PDCCH reception section 208 (FIG. 4) of terminal 200 configure 4 CCEs per a component band as a common search space for each component band, as shown in FIG. 6. Moreover, the CCE aggregation level of PDCCH provides any one of values of 1, 2 and 4. That is, as shown in FIG. 6, in the search space of one downlink component band, the PDCCH assignment candidates of the respective CCE aggregation levels (1, 2, 4) are 7 candidates in total.

Moreover, setting section 101 (FIG. 3) of base station 100 sets two kinds of formats Format 1A having a small number of information bits and Format 2 having a large number of information bits as formats for a PDCCH signal addressed to each terminal. Therefore, control section 102 configures either Format 1A or Format 2 as a format for a PDCCH signal addressed to each terminal, based upon reception quality information reported by each terminal.

Thus, in the case when a PDCCH signal where the format is Format 1A (that is, a PDCCH signal transmitted with the format having the smallest number of information bits) is inputted from control section 102, scrambling section 105 of base station 100 scrambles the PDCCH signal by using a scrambling sequence corresponding to CFI information inputted from control section 102. In contrast, in the case when a PDCCH signal having Format 2 as its format is transmitted from control section 102, scrambling section 105 does not scramble the PDCCH signal.

PDCCH reception section 208 of terminal 200 carries out a blind decoding process on each of PDCCH assignment candidates within the search space configured on each of a plurality of downlink component bands that are set in the terminal of its own. More specifically, after attempting to decode the PDCCH signal and carrying out a demasking process by using the terminal ID of the terminal of its own for each format of the PDCCH signal inputted from setting information reception section 206, PDCCH reception section 208 carries out an error detection on the PDCCH signal by CRC.

However, upon blind-decoding the PDCCH assignment candidate having Format 1A in its format, PDCCH reception section 208 further carries out a descrambling process on the PDCCH signal after the decoding process, by using a scrambling sequence corresponding to the CFI information of a downlink component band different from the downlink component band on which the PDCCH signal is disposed, in the same manner as in Embodiment 1.

That is, upon carrying out the blind decoding process on the PDCCH assignment candidate having Format 1A in its format, PDCCH reception section 208 carries out two kinds of blind decoding processes, that is, the blind decoding without carrying out descrambling and the blind decoding with descrambling, on each of the downlink component bands. In this ease, the blind decoding process without descrambling refers to a blind decoding process to be carried out on the PDCCH signal to which resource assignment information of the downlink data to be transmitted by the same component band is assigned. In contrast, the blind decoding process with descrambling refers to a blind decoding process to be carried out on the PDCCH signal to which resource assignment information of the downlink data to be transmitted by a difference component band is assigned.

In contrast, upon carrying out the blind decoding process on the PDCCH assignment candidate having Format 2 in its format, PDCCH reception section 208 carries out only the blind decoding process without descrambling on each of downlink component bands.

For example, in the case when base station 100 can assign a PDCCH signal to any one of the downlink component bands, if terminal 200 carries out a descrambling process by using a scrambling sequence corresponding to CFI information on all the formats (in this case, Format 1A and Format 2), the number of decoding attempts of total 56 (=7 (PDCCH assignment candidates)×2 (kinds of blind decoding)×2 (kinds of formats)×2 (downlink component bands)) times are required in the two downlink component bands. In contrast, in the present embodiment, in the two downlink component bands, the number of decoding attempts can be reduced to total 42 (=((7 (PDCCH assignment candidates of Format 2)×1 (kind of blind decoding)+(7 (PDCCH assignment candidates of Format 1A)×2 (kinds of blind decoding processes))×2 (number of downlink component bands)) times.

In base station 100, even in the ease when no scrambling process by the use of CFI information is carried out on a PDCCH signal using Format 2, that has a low possibility of being used as a terminal located in the vicinity of a cell boundary where reception errors of CFI information easily occur (that is, has a high possibility of being used as a terminal located in the vicinity of the center of a cell that is hardly subjected to reception errors in CFI information), the possibility of occurrence of reception errors in CFI information is low. For this reason, the possibility of a HARQ retransmission caused by reception error of CFI information is low.

In contrast, by carrying out a scrambling process by the use of CFI information on a PDCCH signal using Format 1A, that has a high possibility of being used as a terminal located in the vicinity of a cell boundary where reception errors of CFI information easily occur, base station 100 makes it possible to prevent useless HARQ retransmissions caused by reception errors of CFI information, in the same manner as in Embodiment 1.

With this arrangement, in accordance with the present embodiment, even in the case when a terminal uses a plurality of component bands, and transmits a PDCCH signal by using any one of the plurality of formats, it is possible to prevent useless HARQ retransmissions in the same manner as in Embodiment 1. Moreover, in accordance with the present embodiment, since the base station carries out a scrambling process by the use of CFI information only on a PDCCH signal (PDCCH signal having the smallest number of format information bits) for a terminal located in the vicinity of a cell boundary where reception errors of CFI information easily occur, so that it is possible to reduce the number of blind decoding processes in a terminal.

The present embodiment has explained an arrangement in which Format 1A and Format 2 are used as the format of a PDCCH signal. On the other hand, in LTE, in addition to Format 1A, as the format to be received by a terminal, Format 1, Format 1B, Format 1D, Format 2 or Format 2A is designated for each terminal. In the present invention, in place of Format 2, for example, any one of Format 1, Format 1B, Format 1D and Format 2A may be used.

Moreover, in the present embodiment, an explanation has been given by exemplifying an arrangement in which two formats are configured to each terminal as a format for a PDCCH signal, and a scrambling process corresponding to CFI information is carried out only on a PDCCH signal with a format having the smallest number of bits (that is, the format having the smaller number of information bits of the two). However, the present invention can be also applied to an arrangement in which three or more formats are configured to each terminal. In this case, only the PDCCH signal with the format having the smallest number of information bits may be used as a subject for the scrambling process corresponding to CFI information, or PDCCH signals with two formats having small numbers of information bits may be used as subjects for the scrambling process corresponding to CFI information.

Moreover, the PDCCH format may be referred to as DCI (Downlink Control Information) format.

### Embodiment 4

In this embodiment, to a search space corresponding to CFI information of a downlink component band to be used for its data assignment, the base station assigns a PDCCH signal to which resource assignment information of the data is assigned.

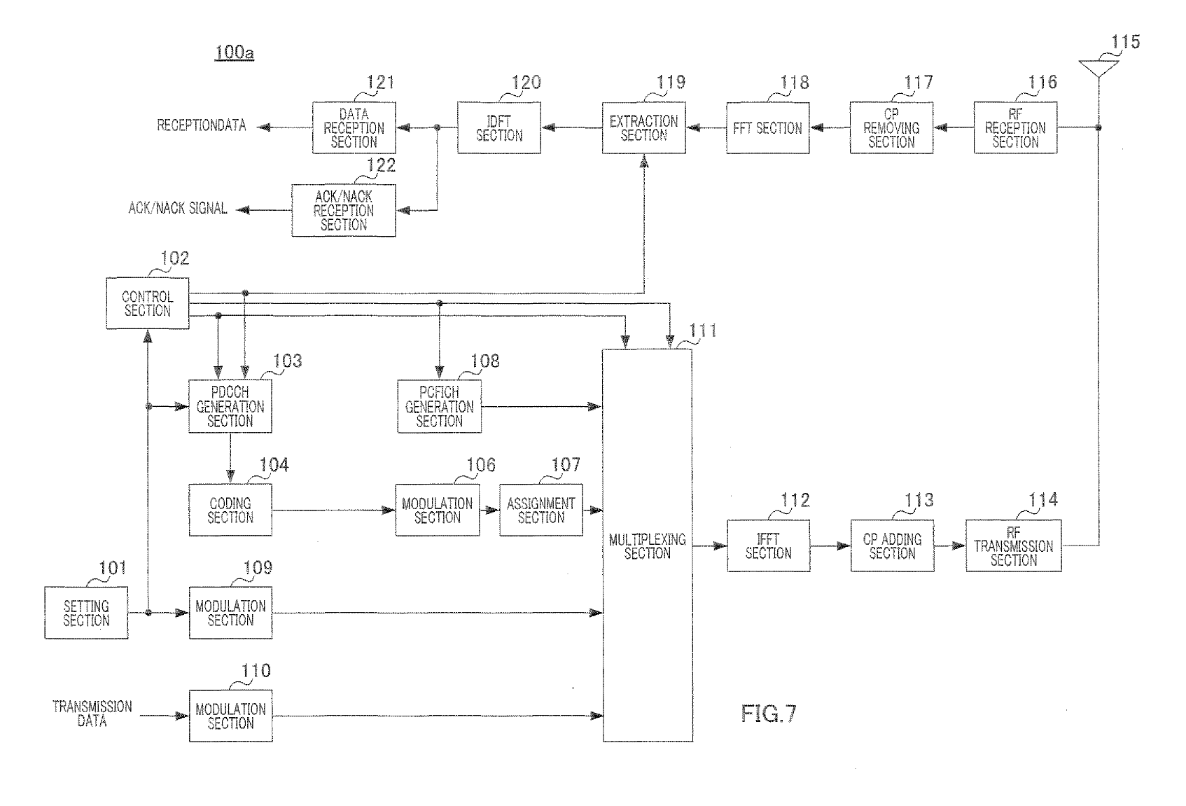

The following description will discuss the present embodiment more specifically. FIG. 7 is a block diagram that illustrates a structure of base station 100a in accordance with the present embodiment. In this case, base station 100a shown in FIG. 7 has a structure that is the same structure as that of base station 100 of Embodiment 1 from which scrambling section 105 is omitted. Moreover, in base station 100a shown in FIG. 7, operations of assignment section 107 are different from those of assignment section 107 of base station 100 shown in FIG. 3.

That is, upon calculating a search space for each of a plurality of downlink component bands configured to the respective terminals, assignment section 107 of base station 100a calculates a search space corresponding to CFI information of a component band of a resource assignment subject indicated by resource assignment information contained in a PDCCH signal addressed to each terminal, which is inputted from modulation section 106.

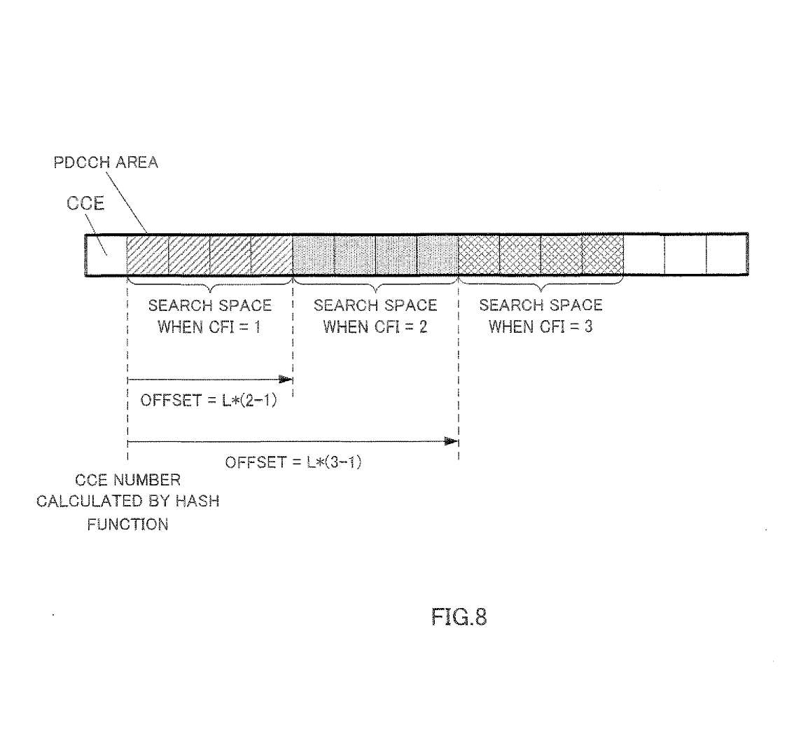

For example, assignment section 107 adds an offset corresponding to CFI information to a CCE number calculated by using a hash function, and may configure a search space by using the resulting value of the addition as a starting position (CCE number) of the search space. More specifically, as shown in FIG. 8, assignment section 107 first calculates the starting position (CCE number) of a search space by using a hash function. Then, assignment section 107 defines an offset corresponding to CFI information as L*(CFI−1). In this case, L represents CCE number constituting a search space (L=4 in FIG. 8), and CFI corresponds to CFI information (CFI=1 to 3 in FIG. 8). As shown in FIG. 8, among mutually different pieces of CFI information (CFI=1 to 3), search spaces corresponding to respective pieces of CFI information do not overlap with one another.

Moreover, assignment section 107 assigns into a search space corresponding to CFI information of a component band of a resource assignment subject indicated by resource assignment information contained in a PDCCH signal, the corresponding PDCCH signal.

On the other hand, although terminal 200 (FIG. 4) has the same structure as that of Embodiment 1, operations of PDCCH reception section 208 are different from those of Embodiment 1. That is, upon calculating a search space for each of a plurality of downlink component bands configured to the terminal of its own, PDCCH reception section 208 calculates a search space corresponding to CFI information of each downlink component band inputted from PCFICH reception section 207, in the same manner as in assignment section 107 (for example, FIG. 8). Then, PDCCH reception section 208 carries out a blind decoding process on the PDCCH signal within a search space corresponding to CFI information inputted from PCFICH reception section 207.

With this arrangement, in the case when CFI information of downlink component band for use in transmitting downlink data is determined correctly, terminal 200 carries out a blind decoding process within a search space set by base station 100a, that is, within a search space to which a PDCCH signal with resource assignment information of downlink data assigned thereto is assigned. Thus, terminal 200 can detect a PDCCH signal.

In contrast, in the case when CFI information of downlink component band for use in transmitting downlink data is erroneously determined, terminal 200 carries out a blind decoding process within a search space different from the search space set by base station 100a, that is, the search space with a PDCCH signal with resource assignment information of downlink data assigned thereto is assigned. In this case, even when a blind decoding process is carried out, terminal 200 cannot detect a PDCCH signal. In other words, in the same manner as in Embodiment 1, in the case when CFI information of downlink component band for use in transmitting downlink data is erroneously determined, terminal 200 also fails to receive the PDCCH signal to which the resource assignment information of the downlink data is assigned.

For this reason, in the same manner as in Embodiment 1, since terminal 200 does not transmit an ACK/NACK signal (that is, DTX), base station 100a transmits the same data, not as retransmission data, but as firstly transmitted data. Therefore, in the case when there is any error in CFI information, since terminal 200 does not receive downlink data erroneously, the downlink data is not stored at an erroneous position in the HARQ buffer. For this reason, in the same manner as in Embodiment 1, no useless HARQ retransmission caused by storing downlink data at an erroneous position of the HARQ buffer occurs, thereby preventing frequent retransmissions of an upper layer (for example, RLC layer). Thus, it becomes possible to reduce a delay in data transmission and also to suppress resource consumption for use in HARQ retransmission; thus, it is possible to improve the throughput and also to reduce the processing amount in base station 100a.

In this manner, in accordance with the present embodiment, within a search space corresponding to CFI information of a downlink component band for use in transmitting downlink data, the base station assigns a PDCCH signal with resource assignment information of the downlink data assigned thereto is assigned. Thus, the terminal is allowed to detect a PDCCH signal only when CFI information is received correctly. That is, upon erroneously determining CFI information, the terminal carries out a blind decoding process at a search space different from the search space to which the PDCCH signal is actually assigned, so that it is possible to prevent useless HARQ retransmissions caused by a CFI error. Therefore, in accordance with the present embodiment, even in the case when, upon allowing a terminal to use a plurality of component bands, a component band used for transmitting data and the component band used for transmitting a PDCCH to which the resource assignment information of the data is assigned are different from each other, it becomes possible to prevent useless HARQ retransmissions, in the same manner as in Embodiment 1.

In the present invention, by calculating a starting position (CCE number) of a search space by using CFI information provided as an input value of a hash function, the base station may set a search space corresponding to each piece of CFI information.

### Embodiment 5

In this embodiment, the base station carries out scrambling processes on every PDCCHs in parallel with one another by using a scrambling sequence corresponding to CFI information of each downlink component band to be used for data assignment.

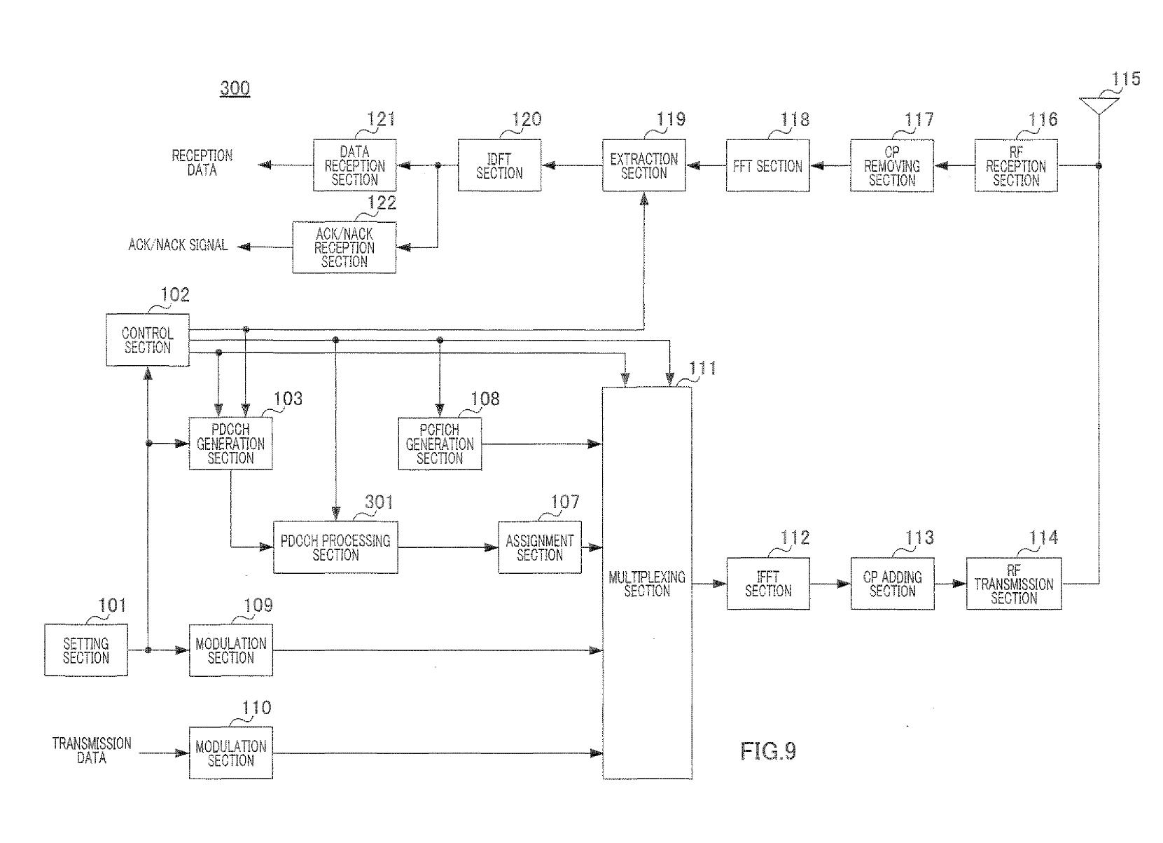

The following description will discuss the embodiment more specifically. FIG. 9 is a block diagram that illustrates a structure of base station 300 in accordance with the present embodiment. Base station 300 shown in FIG. 9 has a structure that is the same structure as that of base station 100 (FIG. 3) of Embodiment 1 except that, in place of coding section 104, scrambling section 105 and modulation section 106, PDCCH processing section 301 is installed.

To PDCCH processing section 301 of base station 300 shown in FIG. 9, PDCCH signals of respective component bands are inputted in parallel with one another from PDCCH generation section 103. Moreover, to PDCCH processing section 301, CFI information (CFI value) for each of downlink component bands is inputted from control section 102. Based upon CFI information of each downlink component band, PDCCH processing section 301 carries out PDCCH processes to be described later in parallel with one another for every PDCCH signals.

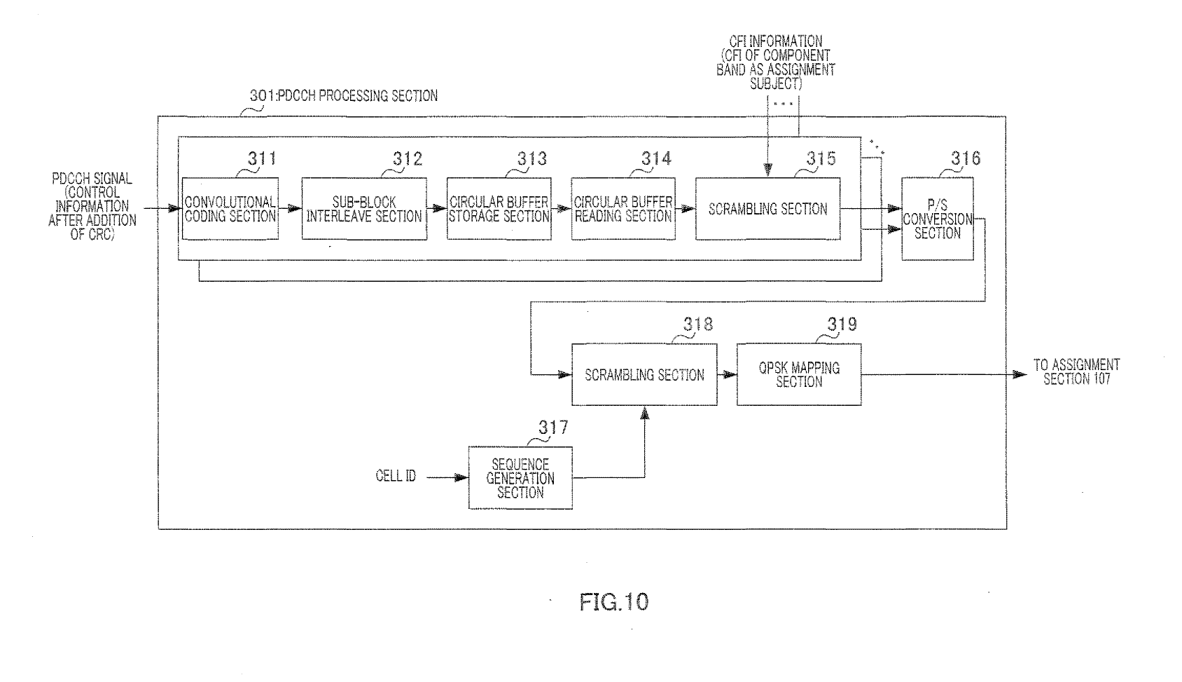

The following description will discuss the PDCCH process in PDCCH processing section 301 in detail. FIG. 10 is a block diagram that illustrates an inner structure of PDCCH processing section 301. As shown in FIG. 10, PDCCH processing section 301 is provided with processing systems which includes convolutional coding section 311, sub-block interleave section 312, circular buffer storage section 313, circular buffer reading section 314 and scrambling section 315, the system corresponding to the number of PDCCH signals that can be simultaneously transmitted by base station 300.

More specifically, in PDCCH processing section 301 shown in FIG. 10, convolutional coding section 311 carries out a convolutional coding process (for example, coding rate R=1/3, locked length K=7) on a PDCCH signal inputted from PDCCH generation section 103 (that is, control information after addition of CRC bits). Then, convolutional coding section 311 outputs the PDCCH signal having been subjected to the convolutional coding process to sub-block interleave section 312.

Sub-block interleave section 312 carries out a block interleaving process with a predetermined pattern on each of bits of a PDCCH signal inputted from convolutional coding section 311. For example, the following description will discuss a case where the coding rate in convolutional coding section 311 is set to R=1/3. In other words, convolutional coding section 311 outputs three bit strings. In this case, sub-block interleave section 312 carries out a block interleaving process with a predetermined pattern on each of three output bit strings outputted from convolutional coding section 311.

Circular buffer storage section 313 stores three bit strings after having been subjected to the interleaving process inputted from sub-block interleave section 312 in one circular buffer (a buffer that allows reading processes cyclically).

Circular buffer reading section 314 reads out bits of the number of which corresponds to the coding rate of a PDCCH signal in succession from the leading portion of the circular buffer. Here, in the case when the coding rate of the PDCCH signal is less than ⅓ (that is, convolutional coding section 311 gives a coding rate of less than R), after having read bits within the circular buffer to the last, circular buffer reading section 314 returns to the leading portion of the circular buffer (makes a circle), and reads out the same bit as that have been once read. In this manner, circular buffer reading section 314 carries out a rate matching process by reading out bit strings with a desired coding rate from the circular buffer.

Among pieces of CFI information of respective downlink component bands inputted from control section 102, by using a scrambling sequence corresponding to CFI information of a downlink component band of a resource assignment subject indicated by downlink resource assignment information contained in a PDCCH signal read out from circular buffer storage section 314, scrambling section 315 carries out a scrambling process on the corresponding PDCCH signal. Additionally, in scrambling section 315, in the same manner as in Embodiment 1, after adding a scrambling sequence, for example, represented by (0, 1) to each of bits, by carrying out a modulo-arithmetic operation (mod 2), a scrambling process is carried out. Moreover, by representing respective bits of data by {1, −1}, scrambling section 315 may multiply each of bits of data by a scrambling sequence represented by {1, −1}.

The respective processes of convolutional coding section 311, sub-block interleave section 312, circular buffer storage section 313, circular buffer reading section 314 and scrambling section 315 are carried out for each PDCCH signal (that is, resource assignment information of each component band of each terminal).

P/S conversion section 316 parallel/serial converts a PDCCH signal (bit string) inputted from each scrambling section 315 of a processing system installed for each PDCCH signal, and outputs the resulting signal to scrambling section 318. Here, the output after the parallel/serial conversion forms a bit string in which PDCCH signals of the respective processing systems are aligned side by side in succession.

Sequence generation section 317 generates a scrambling sequence corresponding to an inputted cell ID. More specifically, sequence generation section 317 generates the scrambling sequence corresponding to a cell ID by inputting an initial value dependent on the cell ID into a pseudo random number (for example, PN sequence) generator. Thus, sequence generation section 317 outputs the generated scrambling sequence to scrambling section 318.

Scrambling section 318 scrambles a PDCCH signal inputted from P/S conversion section 316 by the scrambling sequence inputted from sequence generation section 317 (that is, carries out a cell specific scrambling process by the scrambling sequence corresponding to a cell ID).

QPSK mapping section 319 maps a PDCCH signal (bit string) inputted from scrambling section 318 onto respective signal points of QPSK to generate QPSK signal (PDCCH signal). Moreover, QPSK mapping section 319 outputs the generated QPSK signal (PDCCH signal) to assignment section 107.

In this manner, in accordance with the present embodiment, the base station carries out a scrambling process (that is, scrambling process depending on CFI information) by the use of a scrambling sequence corresponding to CFI information of downlink component band of a resource assignment subject indicated in downlink resource assignment information contained in a PDCCH signal on each PDCCH signal (resource assignment information of each component band for each terminal). That is, the base station executes scrambling processes dependant on CFI information, explained in Embodiment 1, in parallel with one another for each PDCCH signal. Therefore, in accordance with the present embodiment, by carrying out the scrambling processes dependent on CFI information, it is possible to prevent useless HARQ retransmissions in the same manner as in Embodiment 1, and by carrying out scrambling processes dependent on CFI information in parallel with one another for each PDCCH signal, it becomes possible to provide a high speed process (the above-mentioned PDCCH process) in the base station.

### Embodiment 6

In the present embodiment, the base station scrambles a PDCCH signal by using a scrambling sequence corresponding to CFI information and a cell ID (a cell ID of a cell that is covered by a base station).

The following description will discuss the embodiment more specifically. Although base station 300 (FIG. 9) relating to the present embodiment has the same structure as that of Embodiment 5, operations of PDCCH processing section 301 are different from those of Embodiment 5.

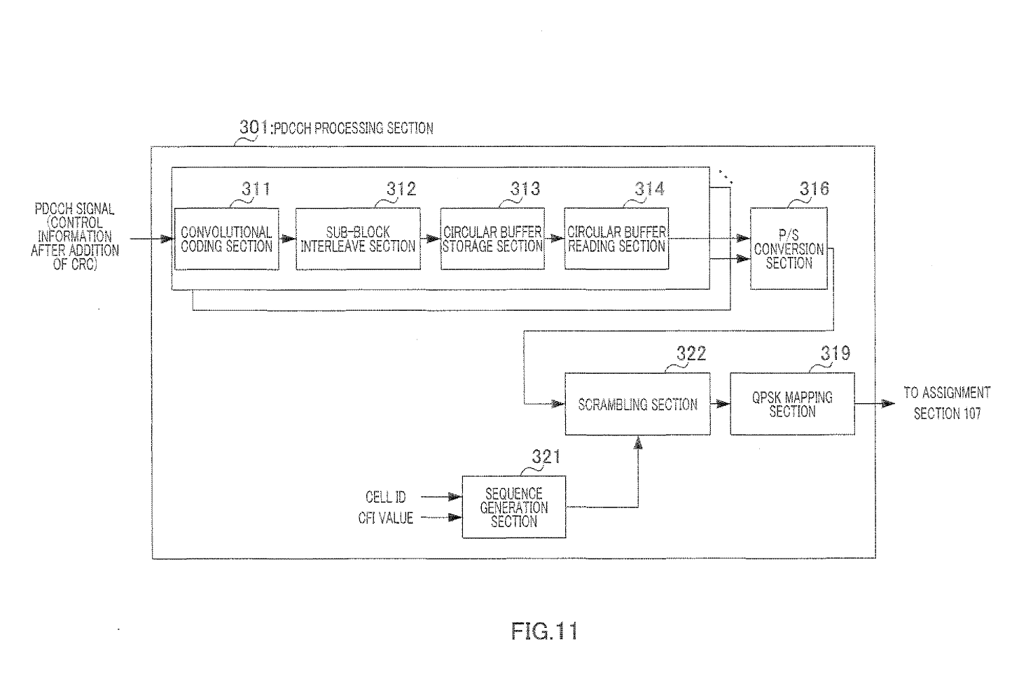

FIG. 11 illustrates an inner structure of PDCCH processing section 301 of base station 300 relating to the present embodiment. Additionally, in FIG. 11, those configuration elements identical to those of FIG. 10 (Embodiment 5) are assigned the same reference codes, and duplicate descriptions thereof are omitted. PDCCH processing section 301 shown in FIG. 11 has a structure that is the same as the structure of PDCCH processing section 301 of Embodiment 5 from which scrambling section 315 is omitted. Moreover, in PDCCH processing section 301 shown in FIG. 11, operations of sequence generation section 321 and scrambling section 322 are different from those of sequence generation section 317 and scrambling section 318 of PDCCH processing section 301 shown in FIG. 10.

Here, an explanation will be given by exemplifying a case where CFI information takes three values, that is, CFI=1, 2 and 3.

In PDCCH processing section 301 shown in FIG. 11, to sequence generation section 321, CFI information (CFI information of each downlink component band) is inputted from control section 102 in addition to a cell ID. Moreover, sequence generation section 321 generates a scrambling sequence corresponding to both of inputted cell ID and each piece of CFI information. More specifically, sequence generation section 321 generates a scrambling sequence corresponding to a cell ID and each piece of CFI information by inputting an initial value dependant on the cell ID and each piece of CFI information into pseudo random number (for example, PN sequence) generator. In this case, since CFI information can take three values of CFI=1, 2 and 3, three scrambling sequences, respectively corresponding to combinations (3 combinations) between each cell ID and each piece of CFI information, are generated. That is, sequence generation section 321 generates three scrambling sequences corresponding to the respective pieces of CFI information as scrambling sequences for use in scrambling (cell specific scrambling) that is commonly conducted on all the terminals within a cell covered by base station 300 over the entire CCEs within a PDCCH area.

Among scrambling sequences (scrambling sequences corresponding to both of cell ID and CFI information) inputted from sequence generation section 321 to respective PDCCH signals (bit string) inputted from P/S conversion section 316, by using a scrambling sequence corresponding to CFI information of downlink component band of a resource assignment subject indicated by downlink resource assignment information contained in the PDCCH signal, scrambling section 322 carries out a scrambling process.

The following description compares Embodiment 5 (FIG. 10) with the present embodiment (FIG. 11). In Embodiment 5 (FIG. 10), the base station carries out two scrambling processes, that is, a scrambling process by using a scrambling sequence corresponding only to CFI information (scrambling process depending on CFI information) (scrambling section 315 shown in FIG. 10) and a scrambling process by using a scrambling sequence corresponding only to cell ID (scrambling process depending on cell ID) (scrambling section 318 shown in FIG. 10). In contrast, in the present embodiment (FIG. 11), the base station carries out one scrambling process, that is, a scrambling process by using a scrambling sequence corresponding to both of cell ID and CFI information (scrambling section 322 shown in FIG. 11).

That is, in contrast to Embodiment 5 where a scrambling process dependent on CFI information and a scrambling process dependent on cell ID are individually carried out, in the present embodiment, only a scrambling process depending on both of CFI information and cell ID is carried out.

With this arrangement, in the present embodiment, without the necessity of newly installing a scrambling section (scrambling section 315 in FIG. 10), a pseudo random number generator (sequence generation section 321 in FIG. 11) that is an existing circuit (circuit used in LTE) used for a scrambling process dependent on a cell ID (that is, a cell specific scrambling process) can be reused also upon generating a scrambling sequence corresponding to CFI information. Therefore, in accordance with the present embodiment, by carrying out a scrambling process dependent on CFI information, since it becomes possible to prevent useless HARQ retransmissions in the same manner as in Embodiment 1, and also to reuse the circuit configuration of an LTE to the maximum level, a base station can be more easily constructed in Embodiment 5.

Additionally, as to whether a downlink component band that is the same as the downlink component band for use in transmitting a PDCCH signal is defined as a resource assignment subject notified by using the corresponding PDCCH signal, or information relating to a downlink component band is added to resource assignment information so that a downlink component band other than the downlink component band for use in transmitting a PDCCH signal is defined as a resource assignment subject notified by using the corresponding PDCCH signal, it is proposed to carry out the corresponding control in a semi-static manner by a base station. In the ease when a downlink component band that is the same as the downlink component band for use in transmitting a PDCCH signal is defined as a resource assignment subject notified by using the corresponding PDCCH signal, since no scrambling process dependent on CFI information is required, only the scrambling process dependent on a cell ID is required. However, in the present embodiment, whether or not the base station carries out a scrambling process dependent on CFI information is only related to whether or not a sequence generation section (sequence generator 321 shown in FIG. 11) generates a scrambling sequence corresponding to CFI information; therefore, both of the arrangements can be realized by using the same circuit configuration.

### Embodiment 7

In the present embodiment, the base station carries out on a PDCCH signal an interleaving process with a pattern corresponding to CFI information of a downlink component band of a resource assignment subject indicated by downlink resource assignment information that is contained in the PDCCH signal. Moreover, upon blind-decoding each of PDCCH signals that are used for resource assignment of data of component bands, each terminal carries out a deinterleaving process by using a pattern corresponding to CFI information of each downlink component band.

The following description will discuss the embodiment more specifically. Although base station 300 (FIG. 9) relating to the present embodiment has the same structure as that of Embodiment 5, operations of PDCCH processing section 301 are different from those of Embodiment 5. Moreover, although a terminal 200 (FIG. 4) relating to the present embodiment has the same structure as that of Embodiment 1, operations of PDCCH reception section 208 are different from those of Embodiment 1.

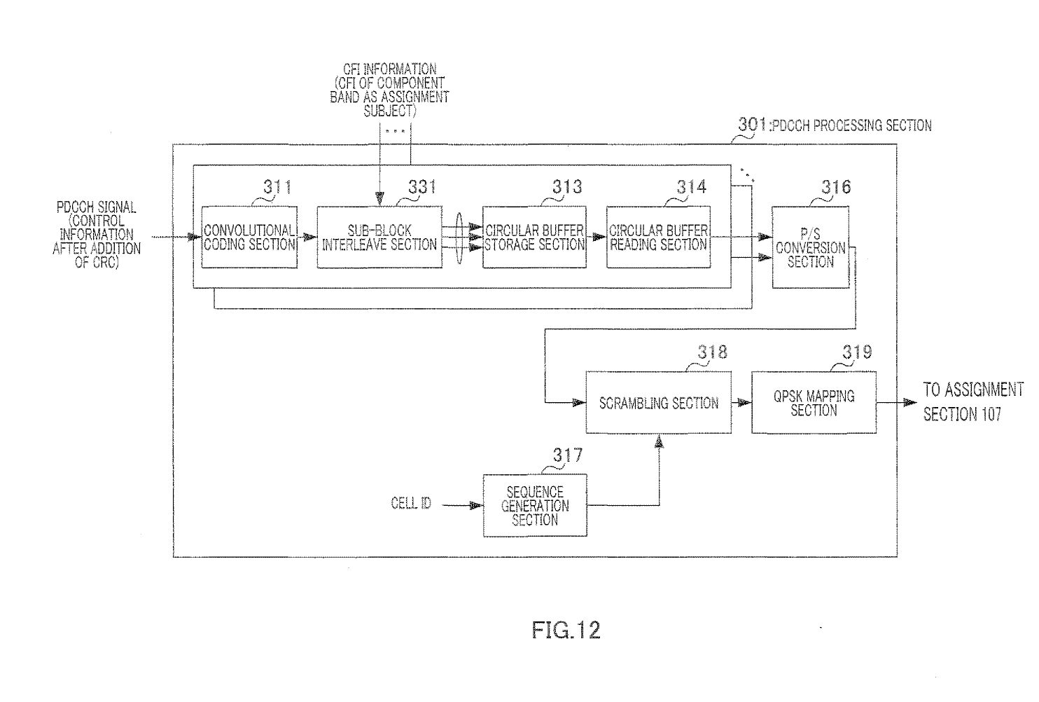

FIG. 12 illustrates an inner structure of PDCCH processing section 301 of base station 300 relating to the present embodiment. Additionally, in FIG. 12, those configuration elements identical to those of FIG. 10 (Embodiment 5) are assigned the same reference codes, and duplicate descriptions thereof are omitted. PDCCH processing section 301 shown in FIG. 12 has a structure that is the same as the structure of PDCCH processing section 301 of Embodiment 5 from which scrambling section 315 is omitted. Moreover, in PDCCH processing section 301 shown in FIG. 12, operations of sub-block interleave section 331 are different from those of sub-block interleave section 312 shown in FIG. 10.

Moreover, in the same manner as in Embodiment 5, an explanation will be given by exemplifying a case where convolutional coding section 311 gives coding rate R=1/3. That is, convolutional coding section 311 outputs three bit strings to sub-block interleave section 331.

In PDCCH processing section 301 shown in FIG. 12, in the case when three output bit strings (PDCCH signals) inputted from convolutional coding section 311 are transmitted by using a downlink component band that is different from a downlink component band of a resource assignment subject indicated by downlink resource assignment information contained in the output bit strings (PDCCH signals), sub-block interleave section 331 carries out an interleaving process with an interleave pattern corresponding to CFI information of the downlink component band to be used for downlink data assignment on each of the three output bit strings (PDCCH signals). For example, interleave patterns corresponding to respective CFIs=1, 2, 3 are preliminarily defined in sub-block interleave section 331. Upon using the block interleave, in sub-block interleave section 331, respective Permutation patterns dependent on respective pieces of CFI information are defined with respect to Permutation pattern for use in rearranging block strings configured by inputted bits. Therefore, sub-block interleave section 331 selects an interleave pattern to be used in accordance with CFI information of downlink component band of resource assignment subject indicated by downlink resource assignment information contained in output bit strings (that is, PDCCH signals), and carries out an interleaving process on the output bits.

On the other hand, upon blind-decoding the respective PDCCHs on which resource assignments of respective component band data are carried out, in place of descrambling the PDCCH signals by using a scrambling sequence corresponding to CFI information (CFI information extracted from each PCFICH signal) of each downlink component band, PDCCH reception section 208 of terminal 200 (FIG. 4) deinterleaves the PDCCH signal by using an interleave pattern corresponding to CFI information of each downlink component band. More specifically, upon blind-decoding a PDCCH transmitted by using a downlink component band different from the downlink component band to be used for downlink data assignment, PDCCH reception section 208 deinterleaves the PDCCH signal that has been demodulated, by using an interleave pattern corresponding to CFI information of downlink component band to be used for downlink data assignment.

With this arrangement, only in the case when CFI information of downlink component band for use in transmitting downlink data is determined correctly, terminal 200 deinterleaves the PDCCH signal to which resource assignment information of the downlink data is assigned, by using the same interleave pattern as the interleave pattern used in PDCCH processing section 301 (sub-block interleave section 331) of base station 300, so that the PDCCH signal can be obtained.

In contrast, in the case when CFI information of downlink component band for use in transmitting downlink data is erroneously determined, terminal 200 fails to correctly identify an interleave pattern to be used for a deinterleaving process. For this reason, when the CFI information of downlink component band for use in transmitting downlink data is erroneously determined, terminal 200 fails to correctly decode the PDCCH signal. Therefore, in the case when there is any error in CFI information of downlink component band for use in transmitting downlink data, since terminal 200 does not receive downlink data by the downlink component band in the same manner as in Embodiment 1, no downlink data is stored at an erroneous position in HARQ buffer. For this reason, in the same manner as in Embodiment 1, as shown in FIG. 2, no useless retransmissions due to storage of downlink data at an erroneous position in HARQ buffer occur, and no frequent retransmissions of upper layer (for example, RLC layer) occur. Thus, it becomes possible to reduce a data transmission delay, and since resource consumption due to HARQ retransmissions can be suppressed, it is possible to improve the throughput and also to reduce the processing amount in base station 300.

In this manner, in accordance with the present embodiment, even in the case when a base station carries out an interleaving process (interleaving process dependent on CFI information) by using an interleave pattern corresponding to CFI information, upon allowing a terminal to use a plurality of component bands, it is possible to prevent useless HARQ retransmissions even when a component band for use in transmitting data and the component band for use in transmitting a PDCCH to which resource assignment information of the data is assigned are different from each other, in the same manner as in Embodiment 1. Moreover, in accordance with the present embodiment, since it is only necessary to change an existing interleave pattern in an existing sub-block interleave circuit to a pattern corresponding to each piece of CFI information, it is possible to realize processing in accordance with the present embodiment by using simple processes.

In the present embodiment, as another method for realizing an interleaving process depending on CFI information, a base station may rearrange bit strings in accordance with CFI information, upon storing three bit strings (in the case of coding rate R=1/3) that have been subjected to the sub-block interleave in a circular buffer. More specifically, supposing that the three bit strings after the sub-block interleave are respectively d1(i), d2(i) and d3(i) (i=1, 2, . . . , N), the base station stores the respective bit strings d1(i), d2(i) and d3(i) in a circular buffer in the order of storage in accordance of CFI information. For example, in the case of CFI=1, the base station stores them in the order of d1(i), d2(i) and d3(i), in the case of CFI=2, the base station stores them in the order of d2(i), d3(i) and d1(i), and in the case of CFI=3, the base station stores them in the order of d3(i), d1(i) and d2(i). With this arrangement, since the base station is only required to change the order of storage of the respective bit strings (PDCCH signals) in a circular buffer, the same processes as those of the present embodiment can be carried out more easily. Moreover, since an existing sub-block interleave circuit for use in LTE can be reused, it is possible to more easily configure the base station and the terminals in accordance with the present embodiment.

### Embodiment 8

In the present embodiment, an arrangement in which a base station carries out on a PDCCH signal an interleaving process by using a pattern (interleave pattern) corresponding to CFI information of a downlink component band of a resource assignment subject indicated by downlink assignment information contained in the PDCCH signal is the same as that of Embodiment 7. However, in Embodiment 7, the base station carries out an interleaving process prior to storing the PDCCH signal in a circular buffer; in contrast, in the present embodiment, the base station carries out an interleaving process on the PDCCH signal after having been read from the circular buffer.

The following description will discuss the embodiment more specifically. Although base station 300 (FIG. 9) relating to the present embodiment has the same structure as that of Embodiment 5, operations of PDCCH processing section 301 are different from those of Embodiment 5.

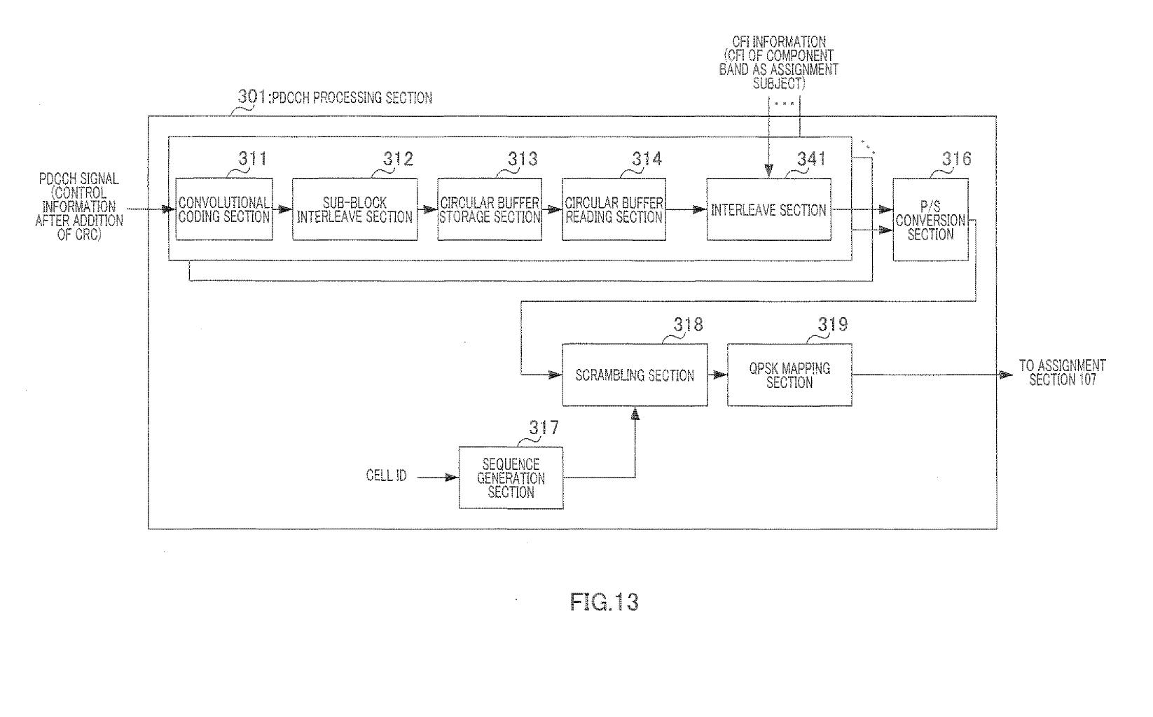

FIG. 13 illustrates an inner structure of PDCCH processing section 301 of base station 300 relating to the present embodiment. Additionally, in FIG. 13, those configuration elements identical to those of FIG. 10 (Embodiment 5) are assigned the same reference codes, and duplicate descriptions thereof are omitted. PDCCH processing section 301 shown in FIG. 13 has the structure of PDCCH processing section 301 according to Embodiment 5, where interleave section 341 is installed in place of scrambling section 315.

In PDCCH processing section 301 shown in FIG. 13, interleave section 341 carries out an interleaving process on a PDCCH signal, by using an interleave pattern corresponding to CFI information of downlink component band of resource assignment subject indicated by downlink resource assignment information contained in the PDCCH signal read out by circular buffer reading section 314 among pieces of CFI information of downlink component bands inputted from control section 102. For example, it is supposed that interleave patterns respectively corresponding to CFI=1, 2 and 3 are preliminarily defined in interleave section 341. For example, in interleave section 341, Permutation patterns dependent on respective pieces of CFI information are defined with respect to Permutation patterns that are used for rearranging block strings configured by the inputted bits upon using block interleaves. In this case, interleave section 341 selects an interleave pattern to be used depending on CFI information of downlink component band of resource assignment subject indicated by downlink resource assignment information contained in a PDCCH signal, and carries out an interleaving process on the PDCCH signal.

In this case, in the present embodiment, when compared with Embodiment 7 (FIG. 12), it is necessary to newly install a circuit (interleave section 341 shown in FIG. 13) that carries out an interleaving process. However, in the present embodiment, with respect to circuits from convolutional coding section 311 to circular buffer reading section 314 shown in FIG. 13 (that is, among processing systems in association with respective PDCCH signals shown in FIG. 13, circuits other than interleave section 341), existing circuits for use in LTE can be reused. Consequently, in the present embodiment, in the same manner as in Embodiment 7, even in the case when a base station carries out an interleaving process (interleaving process dependent on CFI information) by using an interleave pattern corresponding to CFI information, it is possible to prevent useless HARQ retransmissions, and also to reduce the number of testing processes upon designing circuits, in comparison with Embodiment 7.

Additionally, in the present embodiment, as another method for realizing an interleaving process dependent on CFI information, the base station may carry out on a PDCCH signal cycle shifts (cycle shifts dependent on CFI information) in an amount corresponding to CFI information of downlink component band indicated by resource assignment information contained in the PDCCH signal. Upon using cycle shifts, the base station may cycle shift the PDCCH signal in either forward direction or reverse direction. In this manner, since the base station can easily realize an interleaving process by using cycle shifts, it becomes possible to more easily configure the base station and terminal in accordance with the present embodiment.

Moreover, in the present embodiment, the base station may Carry out an interleaving process dependent on CFI information on symbol strings after having been subjected to QPSK modulation (process of QPSK mapping section 319 shown in FIG. 13). Alternatively, upon mapping a PDCCH signal on CCE in an assignment section (assignment section 107 shown in FIG. 9), the base station may carry out the mapping of the PDCCH signal by using a pattern corresponding to CFI information of downlink component band indicated by downlink resource assignment information contained in the PDCCH.

### Embodiment 9

In the present embodiment, the base station reads out a PDCCH signal (transmission bit string) from a circular buffer in succession from a reading start position corresponding to CFI information of downlink component band of resource assignment subject indicated by downlink resource assignment information contained in the PDCCH signal. Moreover, upon blind-decoding each of the PDCCH signals for use in assigning data of each component band, the terminal carries out the decoding based upon the reading start position corresponding to CFI information of each downlink component band.

The following description will discuss the present embodiment more specifically. Although base station 300 (FIG. 9) relating to the present embodiment has the same structure as that of Embodiment 5, operations of PDCCH processing section 301 are different from those of Embodiment 5. Moreover, although a terminal 200 (FIG. 4) relating to the present embodiment has the same structure as that of Embodiment 1, operations of PDCCH reception section 208 are different from those of Embodiment 1.

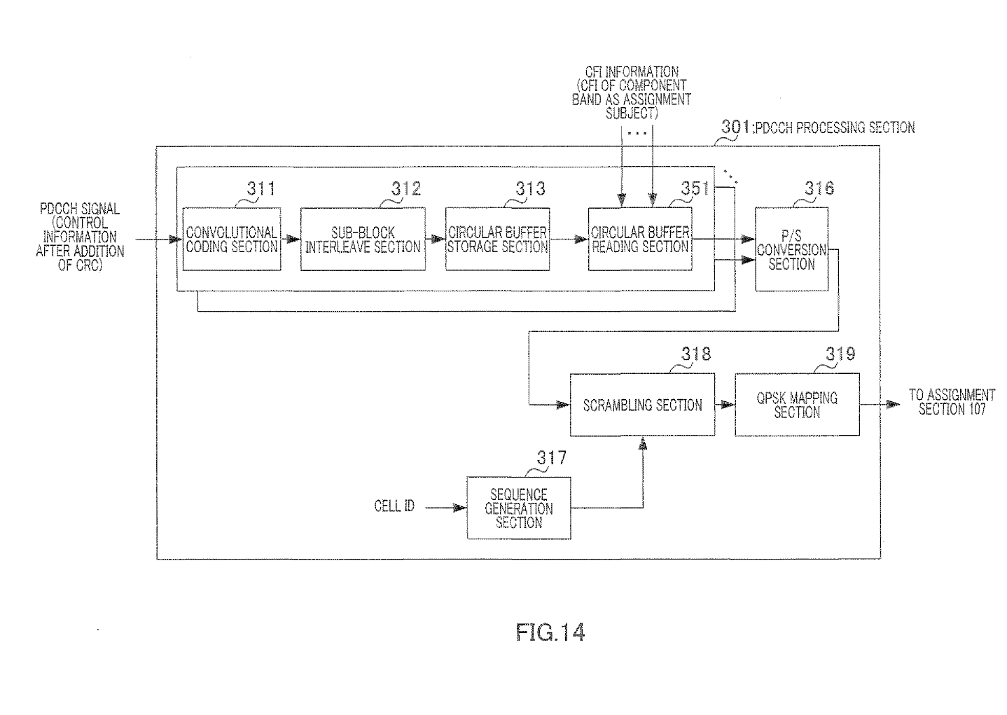

FIG. 14 illustrates an inner structure of PDCCH processing section 301 of base station 300 relating to the present embodiment. Additionally, in FIG. 14, those configuration elements identical to those of FIG. 10 (Embodiment 5) are assigned the same reference codes, and duplicate descriptions thereof are omitted. PDCCH processing section 301 shown in FIG. 14 has a structure that is the same as the structure of PDCCH processing section 301 of Embodiment 5 from which scrambling section 315 is omitted. Moreover, in PDCCH processing section 301 shown in FIG. 14, operations of circular buffer reading section 351 are different from those of circular buffer reading section 314 shown in FIG. 10.

In PDCCH processing section 301 (FIG. 14) of base station 300, circular buffer reading section 351 reads out bits of the number of which corresponds to the coding rate of a PDCCH signal, from the circular buffer, in succession from reading start position corresponding to CFI information of downlink component band of resource assignment subject indicated by downlink resource assignment information contained in the PDCCH signal. More specifically, upon transmitting a PDCCH signal by using a downlink component band different from the downlink component band of downlink resource assignment subject indicated by downlink resource information contained in the PDCCH signal, circular buffer reading section 351 reads out bits of the number of which corresponds to the coding rate of the PDCCH signal from the circular buffer, in succession from a reading start position corresponding to CFI information of downlink component band for use in assigning the downlink data.

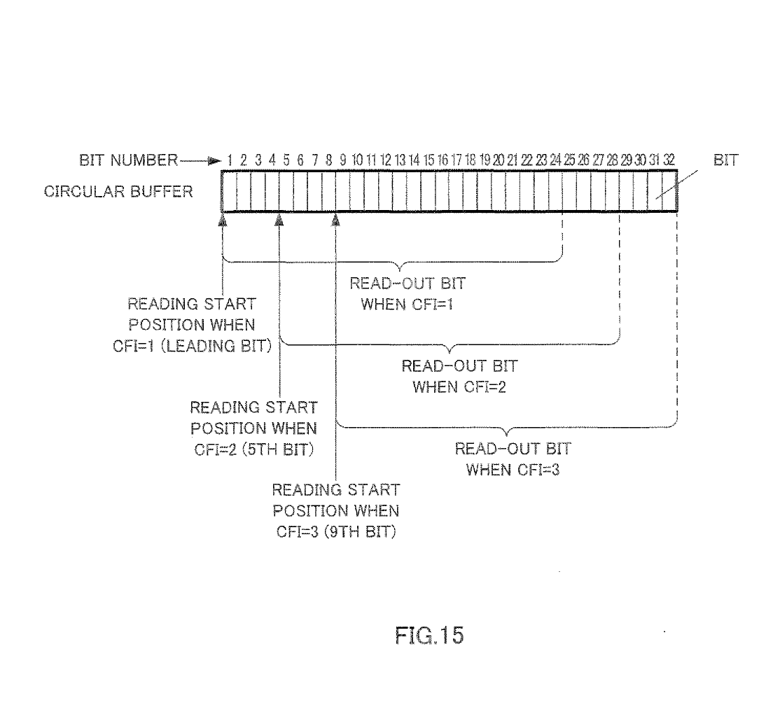

For example, as shown in FIG. 15, circular buffer reading section 351 sets a reading start position for a PDCCH signal containing resource assignment information of a downlink component band of CFI 1 at the leading portion (1st bit) of a circular buffer, sets a reading start position for a PDCCH signal containing resource assignment information of a downlink component band of CFI=2 at 5th bit of the circular buffer, and also sets a reading start position for a PDCCH signal containing resource assignment information of a downlink component band of CFI=3 at 9th bit of the circular buffer. In other words, circular buffer reading section 351 sets a reading start position for a PDCCH signal containing resource assignment information of downlink component band of each CFI at ((nCFI−1)×4+1)th bit of the circular buffer. Here, nCFI represents CFI information (CFI=2, 3 in this case).

On the other hand, upon blind-decoding each PDCCH for use in resource assigning data of each component band, PDCCH reception section 208 (FIG. 4) of terminal 200 returns the PDCCH signal (bit string) to its correct position based upon CFI information of each downlink component band (CFI information extracted from a PCFICH signal). More specifically, upon blind-decoding a PDCCH transmitted by a downlink component band different from the downlink component band for use in assigning downlink data, PDCCH reception section 208 shifts the bit position of the PDCCH signal after the demodulation by a degree corresponding to the number of bits (reading start position at base station 300) corresponding to CFI information of downlink component band to be used for downlink data assignment. Then, PDCCH reception section 208 carries out a decoding process (for example, Viterbi decoding) in association with the convolutional coding at base station 300 on the bit string returned to the correct position.

For example, upon blind-decoding a PDCCH for use in resource-assigning downlink component band of CFI=1, as shown in FIG. 15, PDCCH reception section 208 carries out a decoding process on the PDCCH signal (bit string, that is, bit string read out successively from the 1st bit of the circular buffer in base station 300) at a position as is. On the other hand, upon blind-decoding a PDCCH for use in resource-assigning downlink component band of CFI=2, as shown in FIG. 15, PDCCH reception section 208 shifts the PDCCH signal (bit string, that is, bit string obtained by reading the 5th bit and thereafter of circular buffer in base station 300) rearward by 5 bits. Then, PDCCH reception section 208 carries out a decoding process on the PDCCH signal (bit string formed by disposing a bit string from base station 300 at 5th bit and thereafter). In the same manner, upon blind-decoding a PDCCH for use in resource-assigning downlink component band of CFI=3, as shown in FIG. 15, PDCCH reception section 208 shifts the PDCCH signal (bit string, that is, bit string obtained by reading the 9th bit and thereafter of circular buffer in base station 300) rearward by 9 bits. Moreover, PDCCH reception section 208 carries out a decoding process on the PDCCH signal (bit string obtained by disposing a bit string from base station 300 at the 5th bit and thereafter).

At this time, in the case when terminal 200 has erroneously received CFI information of downlink component band for use in transmitting downlink data, since, upon decoding, the bit positions of the PDCCH signal (bit string) are not correct, the decoding relating to the PDCCH signal (bit string) becomes equivalent to the decoding relating to a random sequence, causing CRC to become NG. That is, in terminal 200, in the case when CFI information of downlink component band for use in transmitting downlink data is erroneously determined, the reception of the PDCCH signal to which the resource assignment information of the downlink data is assigned is also erroneously received (no PDCCH signal addressed to the terminal of its own is detected).

In this manner, only in the case when terminal 200 correctly determines CFI information of the downlink component band for use in transmitting downlink data, bit positions read out from the circular buffer in base station 300 can be identified correctly, so that the PDCCH signal returned to its correct bit position can be decoded, thereby making it possible to obtain a PDCCH signal addressed to the terminal of its own.

Therefore, in the same manner as in Embodiment 1, in the case when there is any error in CFI information of downlink component band for use in transmitting downlink data, since terminal 200 does not receive downlink data by using the corresponding downlink component band, the downlink data is not stored at an erroneous position in the HARQ buffer. For this reason, as shown in FIG. 2, no useless HARQ retransmission caused by storing downlink data at an erroneous position of the HARQ buffer occurs, thereby preventing frequent retransmissions of an upper layer (for example, RLC layer) in the same manner as in Embodiment 1. Thus, it becomes possible to reduce a delay in data transmission and also to suppress resource consumption for use in HARQ retransmission; thus, it is possible to improve the throughput and also to reduce the processing amount in base station 300.

As described above, in accordance with the present embodiment, even in the case when the base station reads out bits (PDCCH signal) from the circular buffer in succession from the reading start position corresponding to CFI information, as well as in the same manner as in Embodiment 1, even in the case when, upon allowing a terminal to use a plurality of component bands, a component band for use in transmitting data and the component band for use in transmitting a PDCCH to which resource assignment information of the data is assigned are different from each other, it becomes possible to prevent useless HARQ retransmissions.

In the present embodiment, since a convolutional code that is a non-organized code is used as a channel code for a PDCCH, no degradation of error rate due to changing a reading position of the circular buffer occurs. Moreover, upon application of an organized coding such as a turbo coding as a channel code for a PDCCH, since the error rate deteriorates when systematic bits are excluded from the reading subject, only the reading positions corresponding to parity bits may be changed in response to CFI information.

### Embodiment 10

The present embodiment is different from Embodiment 1 in that upon carrying out a scrambling process on a PDCCH signal, the base station carries out the scrambling process by using not only a scrambling sequence corresponding to CFI information of downlink component band of resource assignment subject indicated by downlink resource assignment information contained in the PDCCH signal, but also a scrambling sequence corresponding to the downlink component band of the resource assignment subject.

The following description will discuss the embodiment more specifically. Although base station 100 (FIG. 3) and terminal 200 (FIG. 4) relating to the present embodiment have the same structures as those of Embodiment 1, operations of scrambling section 105 and PDCCH reception section 208 are different those of Embodiment 1.

Upon transmitting a PDCCH signal inputted from coding section 104 by using downlink component band different from the downlink component band of resource assignment subject indicated by downlink resource assignment information contained in the PDCCH signal, scrambling section 105 of base station 100 scrambles the PDCCH signal by using a scrambling sequence corresponding to both of a component band number of the downlink component band for use in assigning the downlink data and CFI information.

Here, PDCCH reception section 208 of terminal 200 blind-decodes each of PDCCHs that resource-assigns data of each component band. In this case, upon blind-decoding the PDCCH transmitted by using downlink component band different from the downlink component band for use in resource-assigning the downlink data, PDCCH reception section 208 descrambles the PDCCH signal after the demodulation by using scrambling sequence corresponding to both of a component band number of the downlink component band for use in assigning the downlink data and CFI information.

That is, in the case when, upon blind-decoding PDCCH signals that resource-assign data of respective component bands, the downlink component bands (component band numbers) of resource assignment subject indicated by downlink resource assignment information contained in the PDCCH signals are different from each other in terminal 200, the scrambling sequences for use in descrambling also become different from each other. For this reason, it is possible to prevent terminal 200 from erroneously detecting a PDCCH signal that takes a downlink component band, that is different from the downlink component band that a PDCCH signal of a blind decoding subject takes as the resource assignment subject, as a resource assignment subject.

In the present embodiment, a search space is configured to each of PDCCH signals containing resource assignment information of respective downlink component data, and terminal 200 blind-decodes the respective PDCCH signals containing assignment information of respective downlink component band data. However, in the present embodiment, even in the case when search spaces respectively configured to the respective PDCCH signals are overlapped with one another (that is, with respect to PDCCH signals containing resource assignment information of data with mutually different component bands, there is a possibility of the same CCE becoming assignment candidate), terminal 200 is allowed to detect only the PDCCH signal that is a desired subject in each attempt of blind decoding. Therefore, terminal 200 is allowed to correctly detect a PDCCH signal for use in resource-assigning data of each downlink component band even when search spaces respectively configured to the PDCCH signals are overlapped with one another. For this reason, terminal 200 can correctly determine a downlink component band to which downlink data addressed to the terminal of its own is assigned.

For example, in order to prevent search spaces for PDCCHs indicating resource assignment information for data of respective component bands from being overlapped with one another, it is necessary to reduce the search space or to set larger number of CCEs within the PDCCH area. However, as the degree of freedom for assigning CCEs is reduced by making the search space reduced, probability (CCE blocking probability) of failing to assigning CCEs becomes higher, due to competition with PDCCH signals containing resource assignment information directed to other terminals, so that the data throughput is reduced. In contrast, when a large number of CCEs are set within the PDCCH area, since a time-frequency resource to be maintained for PDCCH transmission increases, with the result that the data throughput is lowered.

However, in the present embodiment, even in the case when search spaces for respective PDCCHs indicating resource assignment information of data of respective component bands are overlapped with one another, terminal 200 can correctly determine a downlink component band to which the corresponding data is assigned. Therefore, it is not necessary to reduce the search space, and it is also not necessary to set a larger number of CCEs within the PDCCH area. Consequently, in the present embodiment, even in the case when search spaces for respective PDCCHs indicating resource assignment information of data of respective component bands are overlapped with one another, the data throughput can be improved. Moreover, in accordance with the present embodiment, since terminal 200 can specify a downlink component band to which data is assigned, by carrying out a blind-decoding process, it is not necessary to add a bit indicating a component band of an assignment subject to resource assignment information, so that it is possible to prevent an increase in overhead of control information.

Furthermore, in terminal 200, in the same manner as in Embodiment 1, in the case when there is any error in CFI information of downlink component band for use in transmitting downlink data, since the downlink component band is not used for receiving downlink data, it is possible to prevent downlink data from being stored at an erroneous position in HARQ buffer. Therefore, in the same manner as in Embodiment 1, as shown in FIG. 2, useless HARQ retransmissions due to storage of downlink data at an erroneous position in HARQ are prevented, thereby making it possible to prevent frequent retransmissions of an upper layer (for example, RLC layer). With this arrangement, it becomes possible to reduce a delay in data transmission and also to suppress resource consumption for use in HARQ retransmission; thus, it is possible to improve the throughput and also to reduce the processing amount in base station 100.

As described above, in accordance with the present embodiment, even in the case when the base station scrambles a PDCCH signal by using not only CFI information but also a scrambling sequence that also corresponds to a component band number of a downlink component band, or even in the case when, upon allowing a terminal to use a plurality of component bands, a component band for use in transmitting data is different from the component band for use in transmitting a PDCCH to which resource assignment information of the data is assigned, it becomes possible to prevent useless HARQ retransmissions, in the same manner as in Embodiment 1.

Moreover, in accordance with the present embodiment, it is possible to configure search spaces for PDCCHs indicating resource assignment information of data of respective component bands so as to be mutually overlapped with one another. With this arrangement, it is possible to improve the data throughput without reducing a search space, as well as without configuring a larger number of CCEs within the PDCCH area.

In the present embodiment, when the base station carries out a scrambling process (or when the terminal carries out a descrambling process), the base station (terminal) may carry out a scrambling process (descrambling process) by using a scrambling sequence corresponding to the component number of a downlink component band and a scrambling process (descrambling process) by using a scrambling sequence corresponding to CFI information of downlink component band, in a separate manner respectively.

Moreover, in the present embodiment, the component band number of downlink component band may be notified from the base station to each terminal, or numbers determined in the entire system (or for each cell) may be used. Alternatively, the component band number of downlink component band may be prepared as a relative number that indicates how far it is separated from a main component band (main band).

In Embodiments 2, 3, 5 and 6, in the same manner as in the present embodiment, a scrambling process dependent on a component band number of downlink component band may be carried out. Moreover, in Embodiment 4, search spaces corresponding to component band numbers of downlink component bands may be configured, or in Embodiments 7 and 8, interleaving processes corresponding to component band numbers of downlink component bands may be carried out, or in Embodiment 9, reading start positions in a circular buffer corresponding to component band numbers of downlink component bands may be set. These arrangements also provide the same effects as those of the present embodiment.

In accordance with the present embodiment, while carrying out a scrambling process dependent on component band number of downlink component band of a resource assignment subject, an interleaving process dependent on CFI information of downlink component band of a resource assignment subject may be carried out as described in Embodiments 7 and 8, or reading start positions for a circular buffer corresponding to component band numbers of downlink component bands may be set as described in Embodiment 9. These arrangements also provide the same effects as those of the present embodiment.

Moreover, in the present embodiment, without carrying out a scrambling process dependent on CFI information of component band of a resource assignment subject on a PDCCH signal, only a scrambling process dependent on component band numbers of downlink component bands of a resource assignment subject may be carried out. In this case, by setting CFI information of each component band to a predetermined fixed value (for example, CFI=3), it is possible to prevent useless HARQ retransmissions caused by storage of downlink data at an erroneous position in HARQ buffer. In this case, however, since an amount of resource directed to PDCCHs (PDCCH area) needs to be set at a fixed amount, control operations in response to a traffic amount or the like cannot be carried out, with the result that degradation of throughput might be caused. For this reason, the above-mentioned process is desirably carried out in a state where fluctuations of the traffic amount seldom occur (for example, in a cell having a large number of users).

Embodiments of the present invention have been described so far.

Additionally, in the above-mentioned embodiments, the largest number of CCEs that can be assigned in one PDCCH is defined as 4. However, in the present invention, the largest number of CCEs that can be assigned in one PDCCH is not intended to be limited by 4, and for example, in LTE, the largest number of CCEs that can be assigned in one PDCCH is 8.

Moreover, in the aforementioned embodiments, an explanation has been given by exemplifying a case where CFI information is used as information that indicates a starting OFDM symbol position of a data signal (PDCCH signal). However, in the present invention, any information other than CFI information may be used as long as it can specify a resource for use in transmitting data signals.

Furthermore, band aggregation may also be called “carrier aggregation.” Furthermore, band aggregation is not limited to a case where continuous frequency bands are aggregated, but discontinuous frequency bands may also be aggregated.

In the present invention, C-RNTI (Cell-Radio Network Temporary Identifier) may be used as terminal ID.

In the present invention, the masking (scrambling) process may be prepared as bit-to-bit multiplication (that is, CRC bit and terminal ID), or may be carried out by mutually adding bits and mod 2 of the addition result (that is, remainder obtained by dividing the result of addition by 2) may be obtained.

Furthermore, a case has been described in the above embodiments where a component band is defined as a band having a width of maximum 20 MHz and as a basic unit of communication bands. However, the component band may be defined as follows. For example, a downlink component band may be defined as a band delimited by downlink frequency band information in a BCH (Broadcast Channel) reported from a base station, or a band defined by a distribution width when a PDCCH is subjected to distributed placement in a frequency band. Also, an uplink component band may also be defined as a band delimited by uplink frequency band information in a BCH reported from a base station, or a basic communication band unit of 20 MHz or less that includes a PUCCH near the center and a PUCCH at both ends. A component band may also be referred to as a component carrier in LTE.

In the present invention, a component band, which is configured for each terminal in setting section 101 (FIG. 3), may be defined as downlink component band set (DL Active Component Set) and uplink component band set (UL Active Component Set). Moreover, a component band for use in transmitting a PDCCH signal may be defined as PDCCH component band set (PDCCH active component carrier set) and so on.

Moreover, in the present invention, the terminal may be designed so that any one of a plurality of component bands to be used by the terminal is defined as a main band of the terminal, and PDCCH signals are always transmitted by the main band. Here, with respect to the component band to be set as the main band, a component band, preliminarily determined by a system (for example, component band for transmitting SCH or P-BCH), may be prepared, or a common component band between terminals may be set for each cell, or a different component band may be set for each terminal. A main band may also be referred to as an anchor band, an anchor carrier, a master band, or a master carrier.

The CCE explained in the aforementioned embodiments represents a logical resource, and upon disposing CCEs in an actual physical time-frequency resource, the CCEs are dispersed over the entire area of the component band, and disposed therein. Also, as long as CCEs functioning as logical resources are divided on an individual component band basis, CCE placement on an actual physical time/frequency resource may be distributed across the entire system band (that is, all component bands).

In the aforementioned embodiments, an explanation has been given by exemplifying a system where the communication band width of the component band is set to 20 MHz; however, the communication band width of the component band is not limited by 20 MHz. The terminal may be referred to as “UE”, and the base station may be referred to as “Node B” or “BS (Base Station).” A terminal ID may also be referred to as “UE-ID.”

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

This application is based on Japanese Patent Application No. 2009-147812 filed in Japan on Jun. 22, 2009 and Japanese Patent Application No. 2009-217135 filed in Japan on Sep. 18, 2009, all the contents, that is, specification, drawings and abstract, of which are hereby incorporated by reference.

### INDUSTRIAL APPLICABILITY

The present invention is applicable to a mobile communication system or the like.

### REFERENCE SIGNS LIST

100, 100a, 300 Base station
200 Terminal
101 Setting section
102 Control section
103 PDCCH generation section
104 Coding section
105, 315, 318, 322 Scrambling section
106, 109, 110, 210, 211 Modulation section
107 Assignment section
108 PCFICH generation section
111 Multiplexing section
112, 214 IFFT section
113, 215 CP adding section
114, 216 RF transmission section
115, 201 Antenna
116, 202 RF reception section
117, 203 CP removing section
118, 204 FFT section
119 Extraction section
120 IDFT section
121 Data reception section
122 ACK/NACK reception section
205 Demultiplexing section
206 Setting information reception section
207 PCFICH reception section
208 PDCCH reception section
209 PDSCH reception section
212 DFT section
213 Mapping section
301 PDCCH processing section
311 Convolutional coding section
312, 331 Sub-block interleave section
313 Circular buffer storage section
314, 351 Circular buffer reading section
316 P/S conversion section
317, 321 Sequence generation section
319 QPSK mapping section
341 Interleave section

1-8. (canceled)

9. A radio communication base station apparatus that transmits a plurality of downlink data addressed to a radio communication terminal apparatus using a plurality of downlink component bands, the radio communication base station apparatus comprising:
a control format indicator (CFI) information generation section that generates CFI information for each of the plurality of downlink component bands, the CFI information indicating the number of symbols that are usable for a plurality of control channels to which each of resource assignment information of the plurality of downlink data are respectively assigned; and
a scrambling section that, when a downlink component band for use in assigning the downlink data and a downlink component band for use in transmitting the control channels to which the resource assignment information are assigned are different from each other in the plurality of downlink component bands, scrambles the control channels using a sequence corresponding to the CFI information of the downlink component band for use in assigning the downlink data.

10. The radio communication base station apparatus according to claim 9, wherein when an aggregation level of control channel elements (CCEs) to be assigned to the control channels is equal or more than a threshold value, when the downlink component band for use in assigning the downlink data and the downlink component band for use in transmitting the control channels to which the resource assignment information are assigned are different from each other in the plurality of downlink component bands, the scrambling section scrambles the control channels using the sequence.

11. The radio communication base station apparatus according to claim 9, wherein when the downlink component band for use in assigning the downlink data and the downlink component band for use in transmitting the control channels to which the resource assignment information are assigned are different from each other in the plurality of downlink component bands, among a plurality of control information formats to be assigned to the control channels, the scrambling section scrambles the control channel to which a control information format having the smallest number of information bits is assigned, using the sequence.

12. The radio communication base station apparatus according to claim 9, wherein the scrambling section scrambles the control channels using the sequence corresponding to the CFI information and a cell ID of a cell covered by the radio communication base station apparatus.

13. The radio communication base station apparatus according to claim 9, wherein the scrambling section scrambles the control channel using the sequence corresponding to the CFI information and the downlink component band for use in assigning the downlink data.

14. A radio communication terminal apparatus that receives a plurality of downlink data using a plurality of downlink component bands, the radio communication terminal apparatus comprising:
a reception section that obtains control format indicator (CFI) information for each of the plurality of downlink component bands, the CFI information indicating the number of symbols that are usable for the control channels to which resource assignment information of downlink data addressed to the radio communication terminal apparatus are assigned; and
a decoding section that descrambles the control channels transmitted by a downlink component band different from a downlink component band for use in assigning the downlink data among the plurality of downlink component bands, using the sequence corresponding to the CFI information of the downlink component band for use in assigning the downlink data.

15. A control channel transmission method performed in a radio communication base station apparatus that transmits a plurality of downlink data to a radio communication terminal apparatus using a plurality of downlink component bands, the control channel transmission method comprising:
generating control format indicator (CFI) information for each of the plurality of downlink component bands, the CFI information indicating the number of symbols that are usable for a plurality of control channels to which each of resource assignment information of the plurality of downlink data are respectively assigned; and
scrambling the control channels using a sequence corresponding to the CFI information of a downlink component band for use in assigning the downlink data, when the downlink component band for use in assigning the downlink data and a downlink component band for use in transmitting the control channels to which the resource assignment information are assigned are different from each other in the plurality of downlink component bands.

16. A control channel reception method performed in a radio communication terminal apparatus that receives a plurality of downlink data using a plurality of downlink component bands, the control channel reception method comprising:
obtaining control format indicator (CFI) information for each of the plurality of downlink component bands, the CFI information indicating the number of symbols that are usable for control channels to which resource assignment information of downlink data addressed to the radio communication terminal apparatus are assigned; and
descrambling the control channels transmitted by a downlink component band different from a downlink component band for use in assigning the downlink data among the plurality of downlink component bands, using a sequence corresponding to the CFI information of the downlink component band for use in assigning the downlink data.
